(19) United States
(12) Patent Application Publication
(10) Pub. No.: US 2014/0100894 A1
(43) Pub. Date: Apr. 10, 2014

(54) SYSTEM AND METHOD FOR RESERVING A PARKING SPACE IN A DWELLING COMPLEX

(71) Applicants: Johnny Blaze Ariemma, Dahlonega, GA (US); Roger Clayton Greer, III, Dahlonega, GA (US); Daniel W. Williams, Bay City, GA (US)

(72) Inventors: Johnny Blaze Ariemma, Dahlonega, GA (US); Roger Clayton Greer, III, Dahlonega, GA (US); Daniel W. Williams, Bay City, GA (US)

(21) Appl. No.: 13/645,467

(22) Filed: Oct. 4, 2012

(51) Int. Cl. G06Q 10/02

(52) U.S. Cl. CPC G06Q 10/02
USPC 705/5

(57) ABSTRACT

Provided is a parking space reservation system for use in a private multi-dwelling complex. Residents of the private multi-dwelling complex can rent their parking spaces to other residents using the reservation system. The parking space reservation system is embodied as a stand-alone device or a networked system interconnected by a communications transport network. The parking space reservation system also provides a means to authorize a guest to park in other resident owned and deeded parking spaces, and also provide security access to the guest during their temporary rental.

### CROSS-REFERENCE TO RELATED APPLICATION

This application claims the benefit of U.S. Provisional Application No. 61/626,929, filed Oct. 4, 2011.

### 1. TECHNICAL FIELD

The instant disclosure relates to a system and method for reserving a parking space in a dwelling complex, and in particular to allow resident owners to offer their assigned parking spaces for rent or share.

### 2. BACKGROUND

The price of real estate in a metropolitan city has increased to a point that has forced dwelling complex developers (such a condominium, an apartment complex, or a residential complex with deeded parking spots) into a situation of providing less than adequate parking for a resident guest. This situation creates disconcerted emotions in residents' to invite a guest to their condominium home due to the lack of available parking spaces.

In a dwelling complex, each resident has their own deeded parking space(s). The assignment of the various parking spaces is typically deeded based on number of bedrooms in each condominium home. There is a vast number of dwelling complex owners who maintain their residence on a part time basis and/or frequently travel and are away from their parking space, either for an extended period of time or during for ex. business hours while they are at work. Thus, there is a unique opportunity to rent their deeded parking space to other residents and/or guests for shortened and extended periods of time requiring the use of their parking as guest parking. Currently, there is no method or system in place for a guest to rent these unoccupied resident owned and/or dwelling complex owned parking spaces for any predetermined period of time. As such, there is a need for a system and method that will allow resident owners to offer their assigned parking spaces for rent/share with other residents of their dwelling or complex.

There are parking solutions currently in the market that provide a means for advertising parking space availability. One such solution is Parking Panda™. Parking Panda™ is an online city-by-city, daily or monthly parking program, which highlights already, established parking garages and residential homes near the renter's destination. That is, Parking Panda™ allows a user to advertise, over the internet, an available parking space. Anyone searching for a spot will have the option to view nearby spots, and rent a spot near their destination. This approach is not especially secure to residential spaces because any one can make a reservation of that parking spot, without any information given to the renter regarding who is renting the space. With that solution, any customer may reserve parking spaces within a traditional parking lot, or the drive way of a home owner near an event, without the need to be onsite when the reservation is made. However, the Parking Panda™ systems do not allow customer having a deeded parking space, in a secure parking area, to rent that space for any period of time due to the regulations of the private dwelling complex, which typically requires key fob access to gain entry into secure parking garage.

Accordingly, there is still a need for a parking system where a user with an assigned/deeded parking space can rent that space for a period of time.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

A parking space reservation system is provided for reserving a parking space in a dwelling complex, where one resident can rent their parking space to another resident of that same dwelling complex. The parking space reservation system may be embodied as a stand-alone device or a networked system interconnected by a communications transport network.

As a stand-alone, the parking space reservation system may be embodied as a kiosk set up inside the dwelling complex, such as in the lobby of an apartment or condominium complex. The kiosk may be maintained as an intermediary to provide the parking transaction between, for example, two resident owners, or a resident owner and a resident owners' guest. The parking space reservation system provides a means to authorize a guest to park in other resident owned and deeded parking spaces. Thus, further to include a facility management group or association sharing facility parking with a resident owner and a resident owners' guest.

These and other objects, features, and/or advantages may accrue from various aspects of embodiments of the present invention, as described in more detail below.

### BRIEF DESCRIPTION OF THE DRAWINGS

Various exemplary embodiments of this invention will be described in detail, wherein like reference numerals refer to identical or similar components or steps, with reference to the following figures, wherein:

FIG. 1 depicts an exemplary illustration of the parking space reservation system of this invention.

FIGS. 2-6 depict various work flow diagrams for the parking space reservation system of this invention.

FIG. 7 is a method flow chart for a resident renting a parking space of another resident using the parking space reservation system of this invention.

FIGS. 7A-7N depict various exemplary renderings of a graphical user interface of the parking space reservation system in accordance with the method of FIG. 7.

FIG. 8 is a method flow chart in which a resident can sign up for the parking space reservation system and make their parking space available for rent using the parking space reservation system of this invention.

FIGS. 8A-8I depict various exemplary renderings of the graphical user interface of the parking space reservation system in accordance with the method of FIG. 8.

FIG. 9 is a method flow chart in which a resident can make their parking space available for rent using the parking space reservation system of this invention.

FIGS. 9A-9C depict various exemplary renderings of the graphical user interface of the parking space reservation system in accordance with the method of FIG. 9.

FIGS. 10A-10F depict various exemplary renderings of the graphical user interface of the parking space reservation system of this invention for allowing a resident to update their profile stored by the system.

FIGS. 11A-11D depict various renderings of the graphical user interface of the parking space reservation system for allowing a resident to view the history of rentals of their parking space.

FIG. 12 is a method flow chart in which a guest without a reservation can locate and purchase available parking spaced via the parking space reservation system.

FIGS. 12A-12K shows depicts various exemplary renderings of the graphical user interface of the parking space reservation system according to the method of FIG. 12.

FIG. 13 is a method flow chart in which a guest with a reservation can access their temporary assigned parking space and resolve reservation problems with the parking space reservation system.

FIGS. 13A-14D depict various exemplary renderings of the graphical user interface of the parking space reservation system according to the method of FIG. 13.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without all of the specific details. In other instances, well-known structures and graphical user interfaces are shown in block diagram form in order to facilitate describing the claimed subject disclosure.

In general, the parking space reservation system disclosed herein may be embodied in a stand-alone kiosk. The kiosk may be set up inside the dwelling complex, such as in the lobby of an apartment or condominium complex. The kiosk may be maintained as an intermediary to provide the parking transaction between, for example, two resident owners, or a resident owner and a resident owners' guest. The parking space reservation system provides a means to authorize a guest to park in other resident owned deeded parking spaces.

This transaction for the parking space reservation system may follow the following process: First a resident wishing to rent their own deeded parking space could sign up to list their parking space(s) for rent. Once signed up, they can set up their own parameters for rental of the parking space, such as date, time, and the duration of when they would like to make their space available to others.

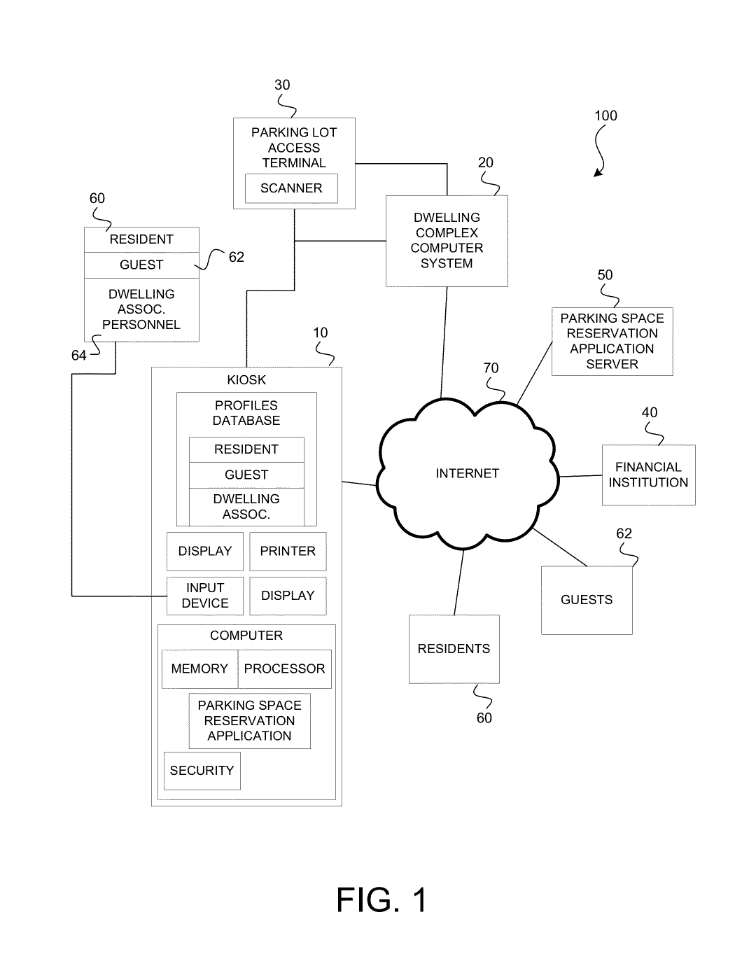

A resident who may need additional guest parking can also use the kiosk to view the availability of the parking spaces of the various other residents in their complex. The resident may use the kiosk to reserve parking for a guest. The reservation can be made for a present or future parking space need. The resident or the guest can be required to pay for a portion, or all, of the parking fee payment using the kiosk. The dwelling complex may opt to utilize a zero-payment system, where the dwelling complex will pay the fees for providing the service to a resident or its guest. At the conclusion of the reservation and upon completion of the transaction, the kiosk can print a parking pass providing the guest with a receipt for the transaction. The payment may be processed in a variety of different ways, such as by a check, electronic payment, credits, or the like. A check in a predetermined amount can be issued and sent to the various participants in the parking space reservation system. The electronic payment may be a PayPal™ transaction and/or other electronic payment processing system. Payment, as a recurring fee, may be made to the kiosk owner for the use of the kiosk, and to the resident who made their space available for rent. Alternatively, credits can be issued that can be used at a future time for a future rental of a parking space in accordance with the parking space reservation system 10, as depicted in FIG. 1. The credits can be used for various purchases and/or services associated with the parking space reservation system program.

FIG. 1 illustrates an exemplary parking space reservation system. The parking space reservation system may be embodied as a stand-alone parking space reservation system 10 or as an interconnected larger networked system 100 through which residents 60, guests 62 and others, such as the dwelling association personnel 64 may access the parking space reservation system parking space reservation system 10 via a large data transport network, such as the Internet 70.

In particular, as a stand-alone parking space reservation system, the parking space reservation system 10 unit may be embodied as a kiosk. The parking space reservation system 10 may include a computer having a processor, memory, security application and a parking space reservation application resident therein. Likewise, a smart mobile device may be integrated for use with the parking space reservation system 10. The mobile device may be for example, a mobile phone, a tablet, and/or other device having a computer processor capable of running the parking space reservation system on a client application resident on the mobile device.

Various profiles for at least the participating residents 60, guests 62 and the dwelling association personnel 64 are provided in a database and accessible through the kiosk. The profiles may include information about each of the residents 60 such as their name, address, parking space to be rented and other pertinent information. Likewise, a profile for a guest 62 may be provided that contains information about the user such as their name, address, car make, model, color and other pertinent information. Furthermore, dwelling association personnel 64 may also participate with those parking spaces under the control of the dwelling association. The dwelling association personnel 64 may be employees or agents of an apartment complex, a condominium complex and/or any other complex that contains assigned parking spaces that may be made accessible and rented out through the parking space reservation system 10.

The parking space reservation system 10 includes a calendar functionality into which the various participating parking spaces may be scheduled for rent at designated times set by the owner of the parking space. In addition to adding reservation dates for a parking space, the calendar function can also remove reservations for a parking spot on a particular day. A color scheme may be added to the parking space reservation system 10. For example, if the reservation is coded a red color, this may imply that the particular reservation cannot be retracted for various reasons, such as it is not possible to cover that parking space by other parking spaces in inventory because none are currently available to cover the red color coded parking space. If the reservation is coded a yellow color, this may imply that the particular reservation can still be assigned to another parking space but caution must be taken as the inventory of available parking spaces is low and a later contemporaneous change may not be possible. Furthermore, if the reservation is coded a blue color, this may imply that the particular reservation may be retracted because there are a number of other available parking spaces in inventory to cover for that particular scheduled time slot.

The parking space reservation system 10 may also include a display to render a graphical user interface. An input/output device component may be incorporated so that various persons 60, 62, and 64 can interact with the parking space reservation system 10. Examples of the input/output device may be a mouse, a keyboard, a stylist, a touch screen, a credit card reader to swipe a credit card and/or any other input/output device capable of operating in accordance with the subject disclosure. The parking space reservation system 10 may also provide a printer contained within the kiosk to print out a copy of the parking permit, the reservation or other indicia.

In accordance with the subject disclosure, the parking space reservation system 10 may be embodied as a networked communications system 100 connected to various persons 60, 62, applications 50, remote servers, and entities. The Internet 70 may be the communications transport network interconnecting the various system modules to each other. As such, the various components of the parking space reservation system 10 may be located remote albeit connected via the Internet 70. For example, the residents 60, the guests 62 and dwelling personnel 64 may access a parking space reservation application server 50 residing at a remote location apart from the parking space reservation system 10 kiosk. At least one financial institution 40 can be connected through the Internet in the parking space reservation system 10, 100.

Likewise, a dwelling complex computer system 20 and a remote parking lot access terminal 30 may be tied into the networked parking space reservation system 100. The remote parking lot access terminal 30 may, for example, be located at the entrance to the parking lot. A scanner integrated into the remote parking lot access terminal 30 may be provided with a wireless RF technology, such as RFID, Near Field Communication, Bluetooth™, Zigby™, 802.11x and/or any other suitable RF technology in accordance with this subject disclosure. The RF detector/reader may be used to detect and analyze permissions given to a guest who has purchased a parking permit for a predetermined period of time.

In one example, the parking permit may have a bar code scanner that when detected by the remote parking lot access terminal 30, it will open a security gate at the parking lot entrance and allow the guest access into the parking lot structure for the designated time in accordance with the scheduled temporary parking permit.

The parking space reservation system 10 and the methods described herein can be executed by a computer processor resident in a kiosk. The kiosk may be conveniently located in a lobby of a condominium complex so that it is accessible to various residents, guests and condominium personnel. As mentioned above, the parking space reservation system may be embodied as a stand-alone device and/or may be tied into various other systems, such as the dwelling complex computer system 20, the network and/or any other suitable device such as a smart mobile device, or any type of portable mobile device running the parking space reservation system on a client application resident on the mobile device.

It should also be appreciated that the parking space reservation system 10, 100 is preferably dynamically implemented on a general-purpose computer. However, the parking space reservation system can also be implemented on a special purpose computer, a programmed microprocessor or microcontroller and peripheral integrated circuit elements, an ASIC or other integrated circuit, digital signal processor, hardwired electronic or logic circuit such as discrete element circuit, programmable logic device such as PLD, PLA, FPGA or PAL, or the like. In general, any device capable of aggregating and scheduling the various parking spaces for the reservation system in accordance with the subject disclosure.

The various components in the parking space reservation system 10 may be interconnected by one or more bidirectional data/control buses or application programming interfaces. Additionally, the computer may be connected over a wireless communication link to the various other components that make up the parking space reservation system 10, 100.

It should be understood that each of the circuits or routines shown in the figures and described below could be implemented as portions of suitably programmed general-purpose computer. Alternatively, each of the circuits or routines could be implemented as physically distinct hardware circuits within an ASIC, or using FPGA, PDL, PLA or PAL, digital signal processor, or using discrete logic elements or discrete circuit elements. The particular form of each of the circuits or routines will take is a design choice.

The parking space reservation system 10 may be implemented using any known or later developed device or system for connecting the one or more of the input devices and the computer, including direct cable connection, connection over wide area network, local network or storage area network, connection over an intranet, connection over the Internet, or connection over any other distributed processing network or system.

The memory can also store one or more computer readable control routines used by the controller to operate the parking space reservation system 10. The memory can be implemented using any appropriate combination of alterable, volatile or non-volatile memory or non-alterable, or fixed, memory. The alterable memory, whether volatile or non-volatile, can be implemented using any one or more of static or dynamic RAM, floppy disk and disk drive, writable or re-writable optical disk and disk drive, hard drive, flash memory or the like. Similarly, the non-alterable or fixed memory can be implemented using any one or more of ROM, PROM, EPROM, EEPROM, an optical ROM disk, such as CD-ROM or DVD-ROM disk, and disk drive or the like.

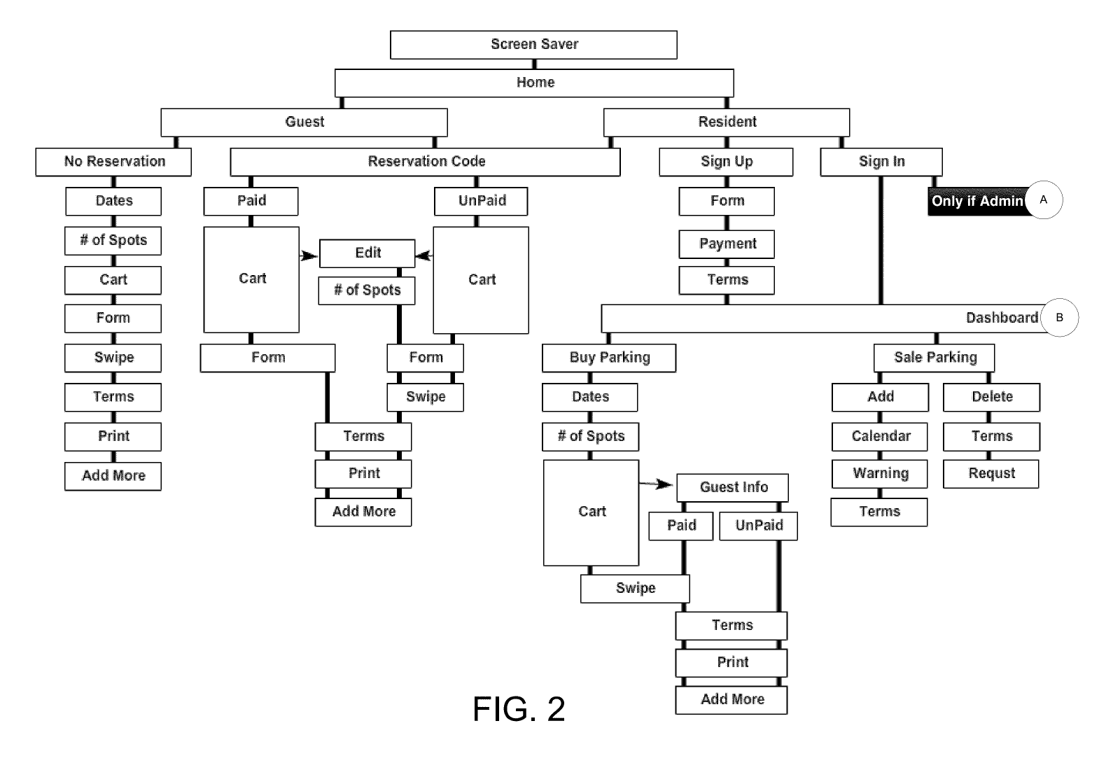

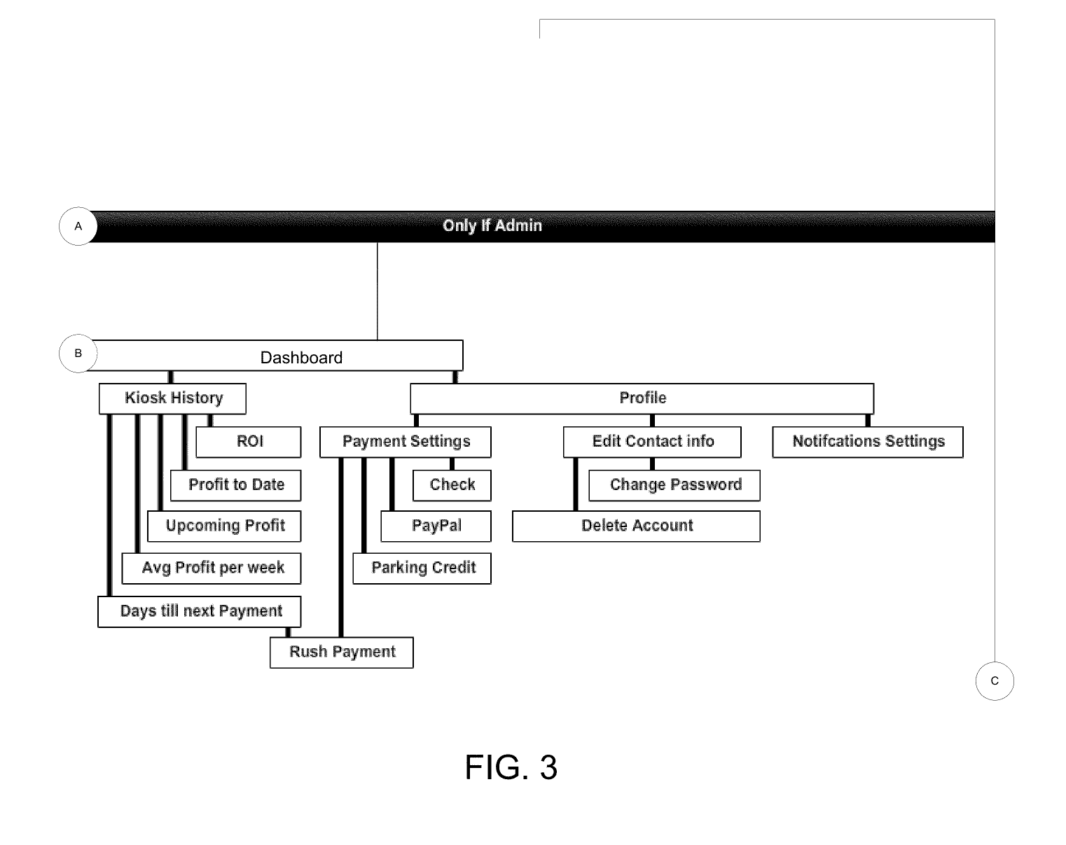

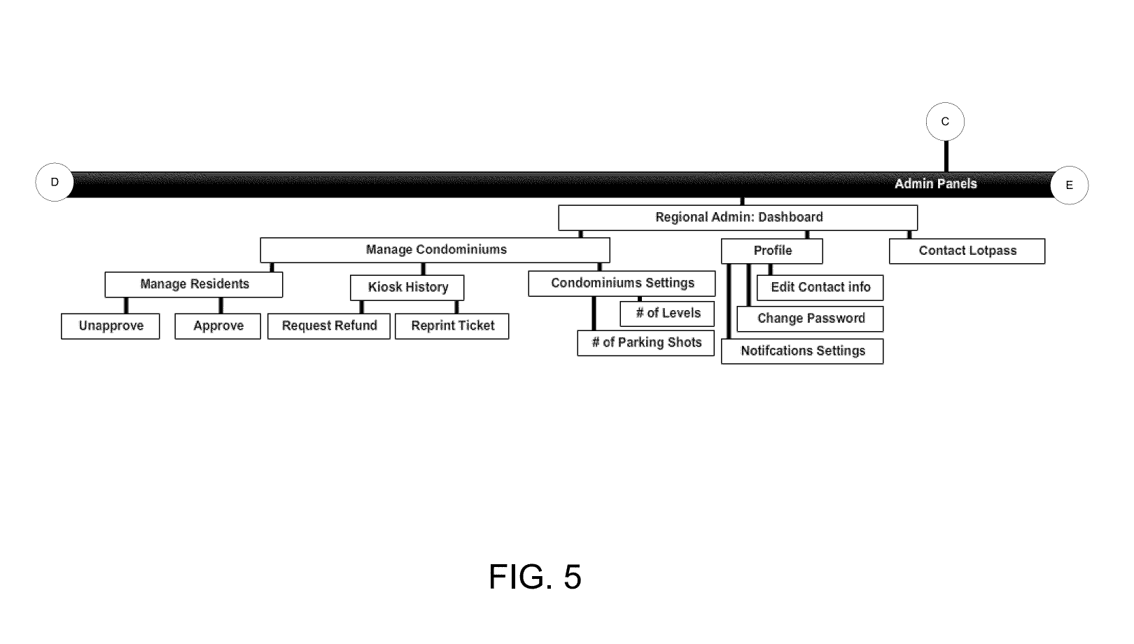

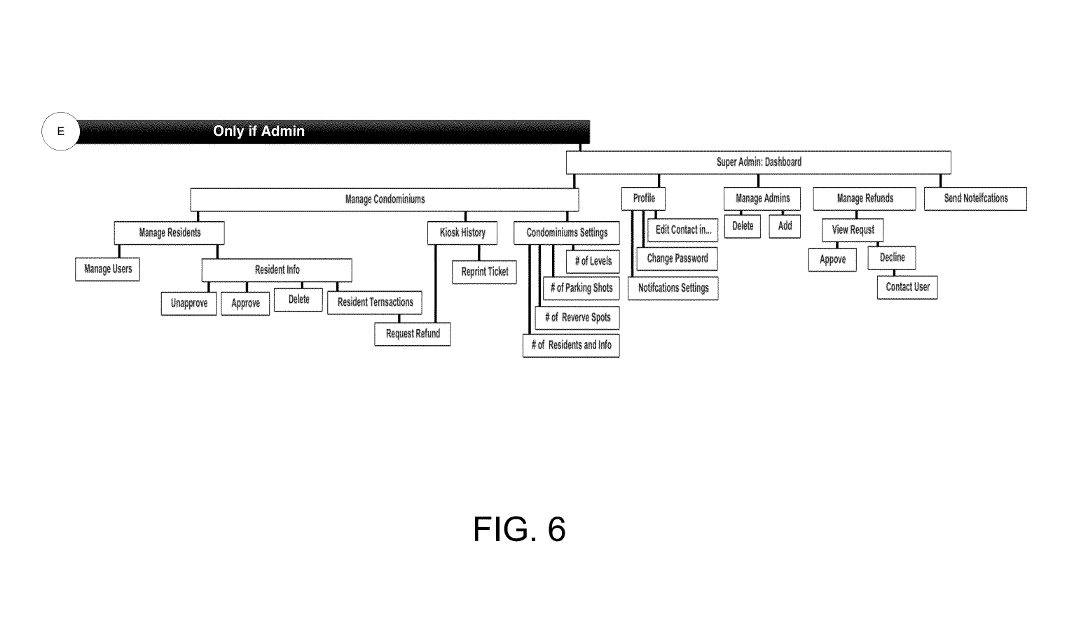

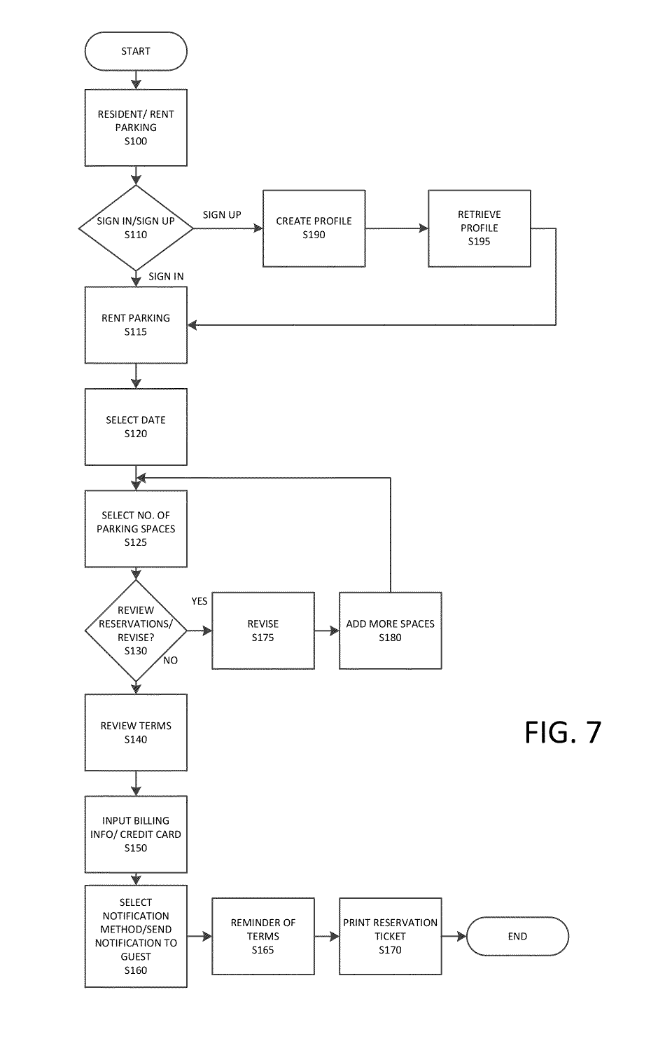

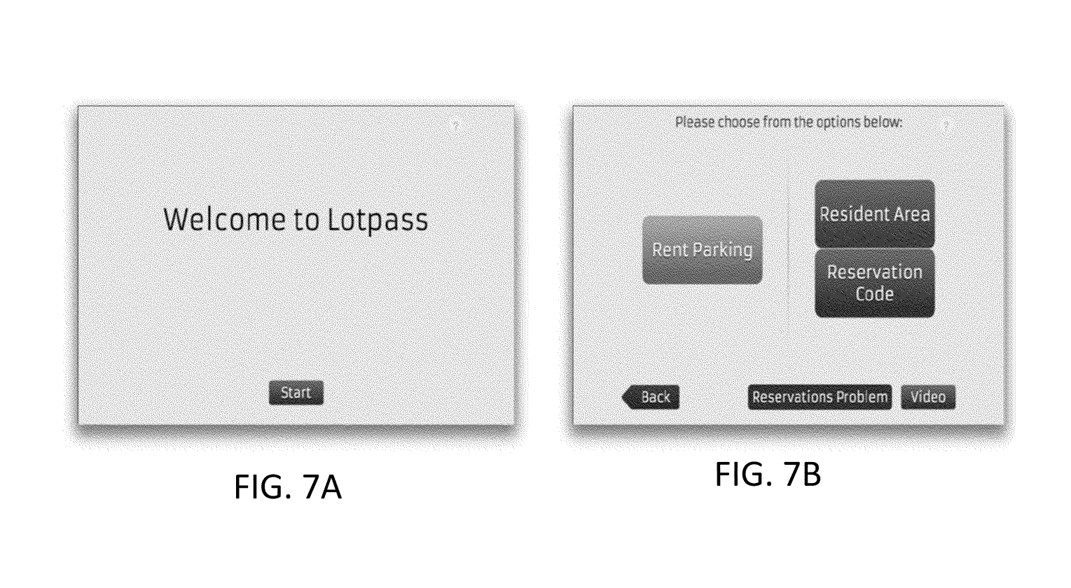

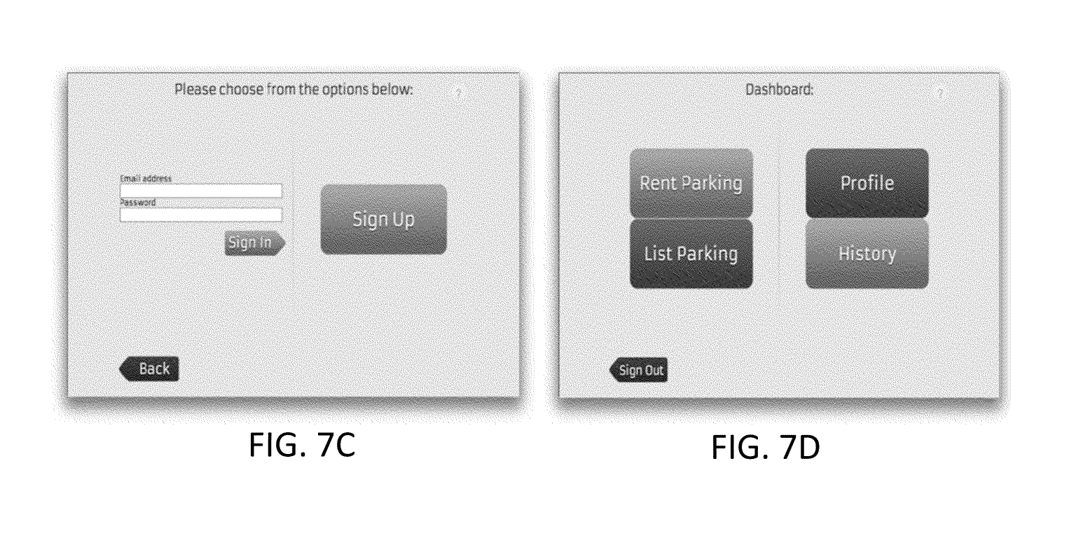

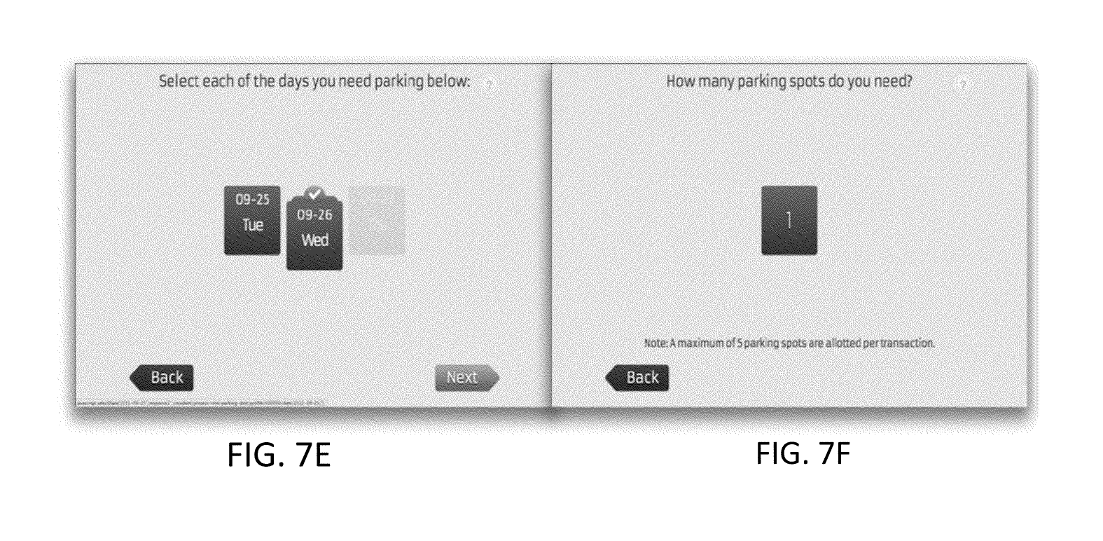

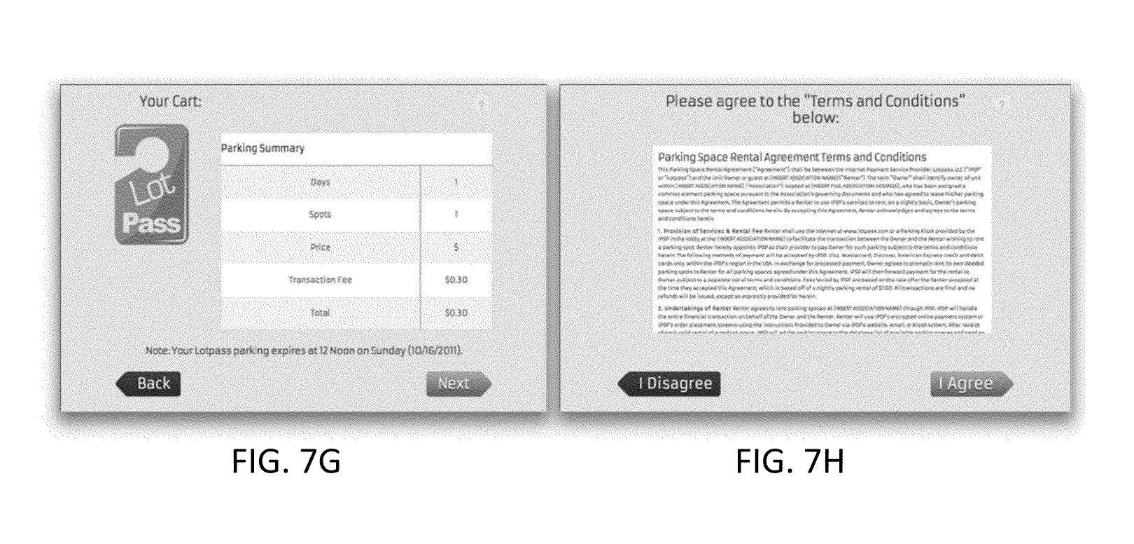

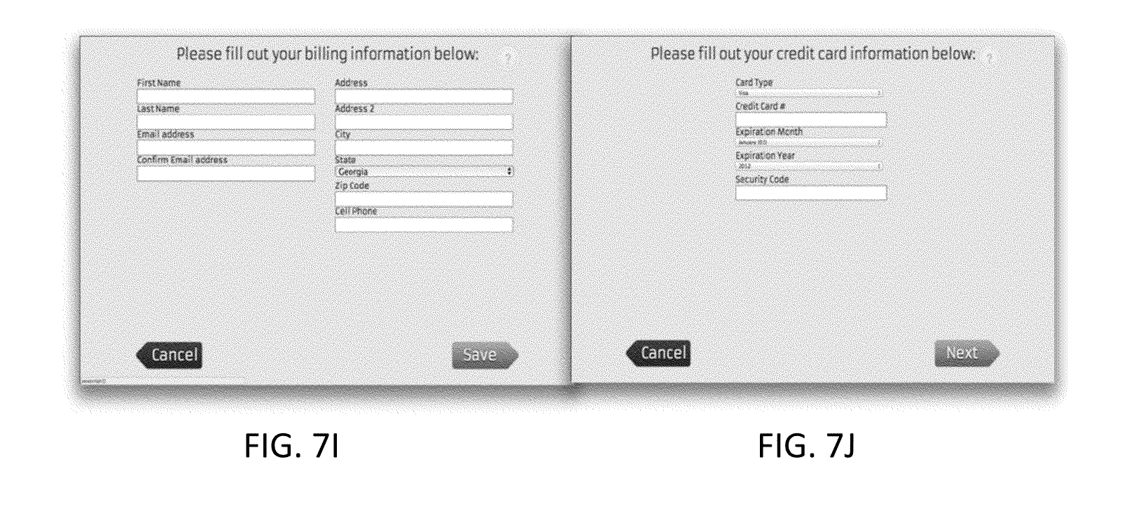

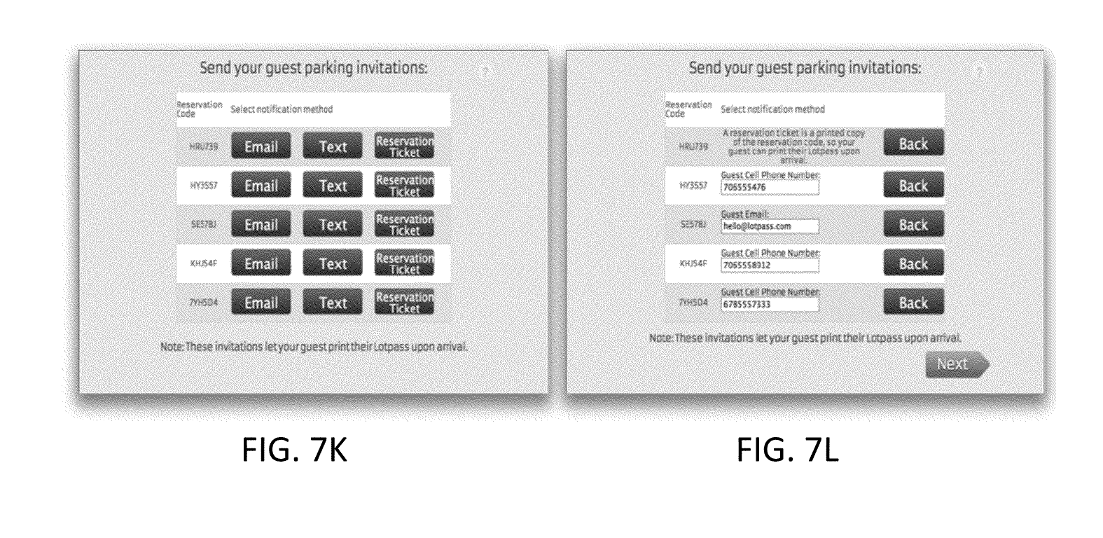

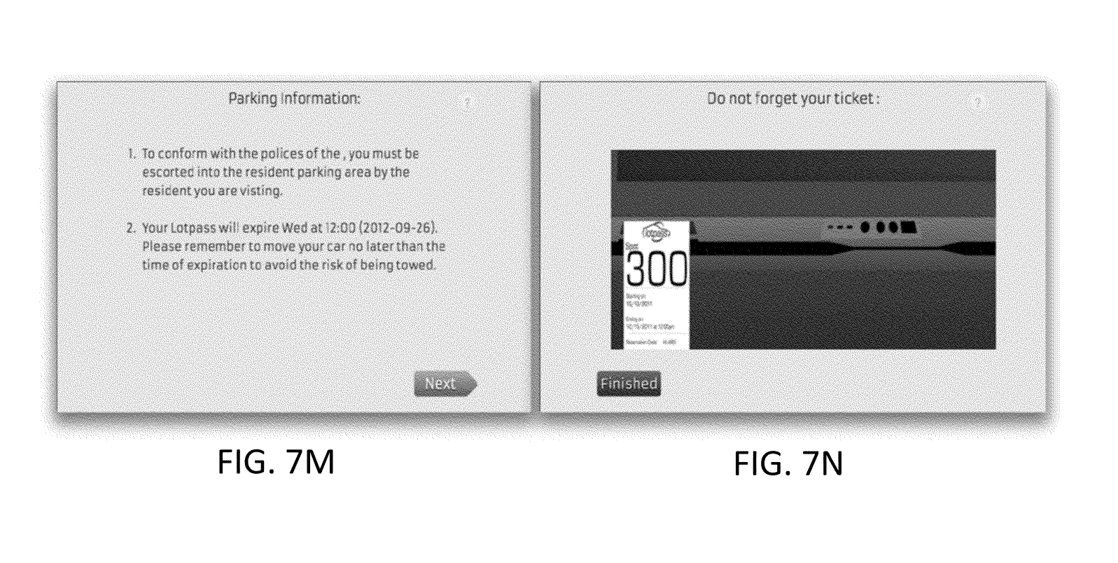

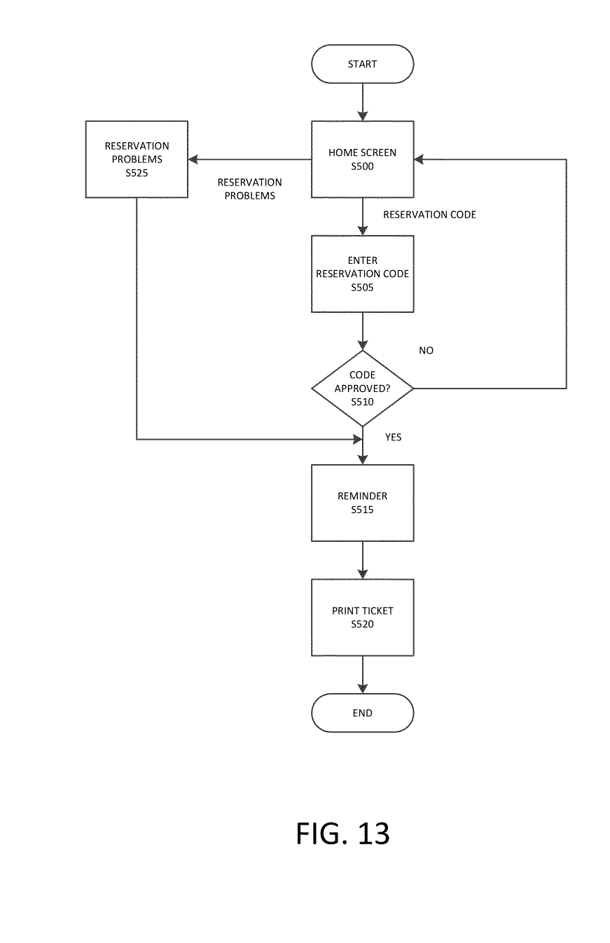

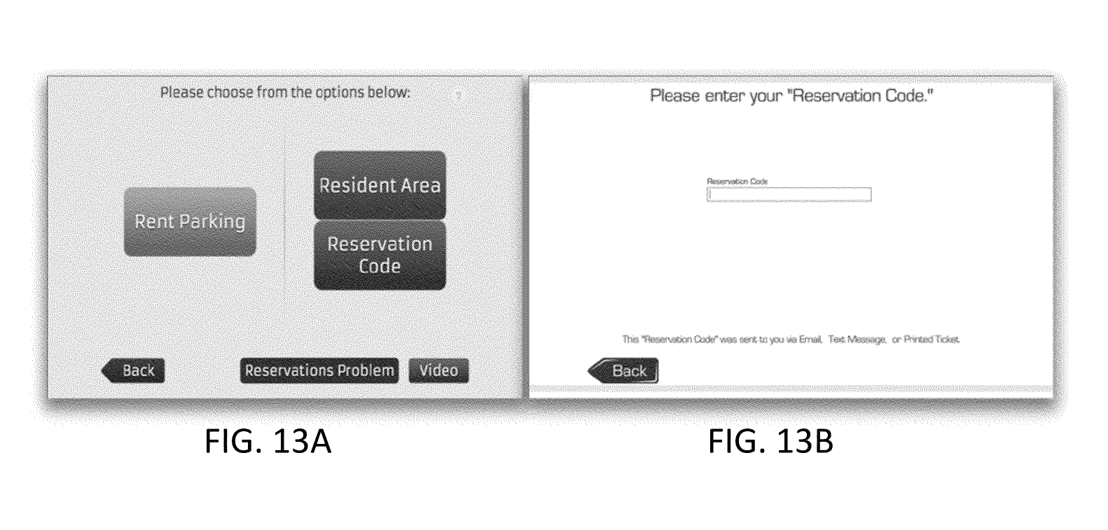

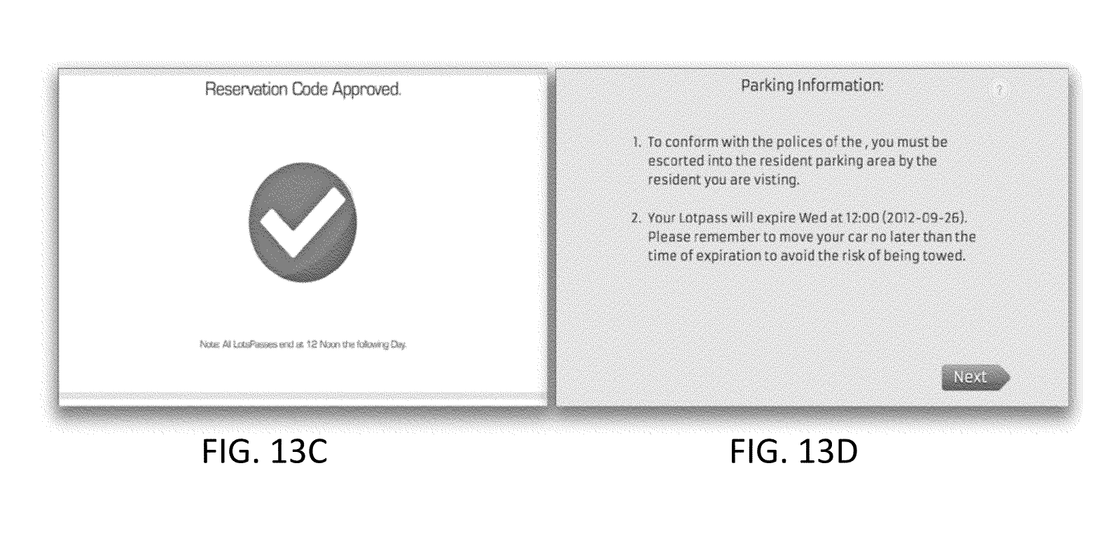

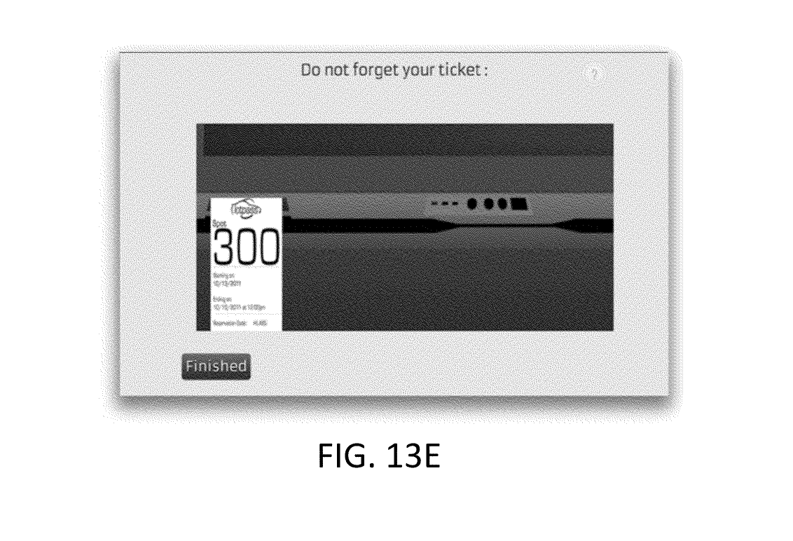

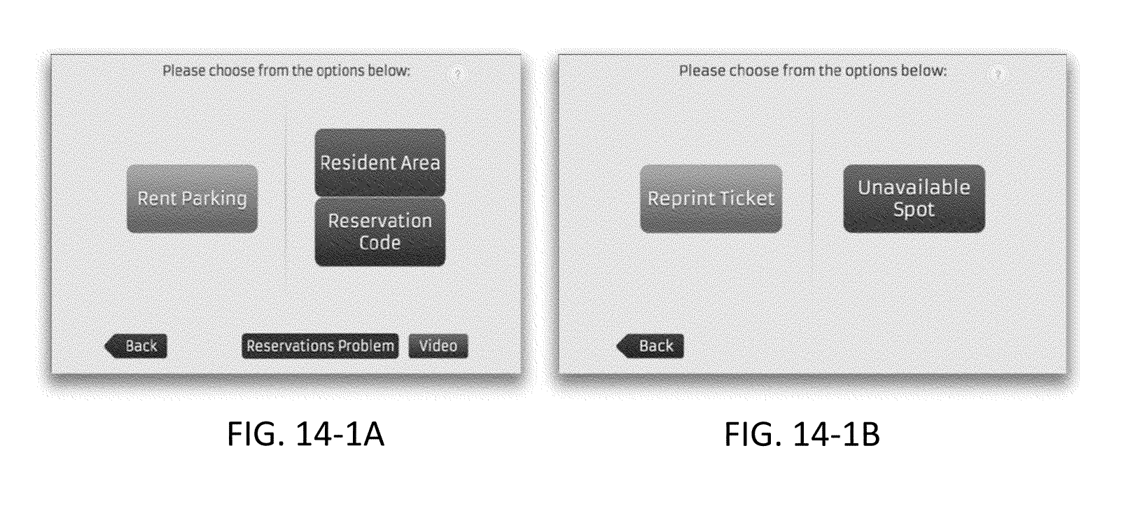

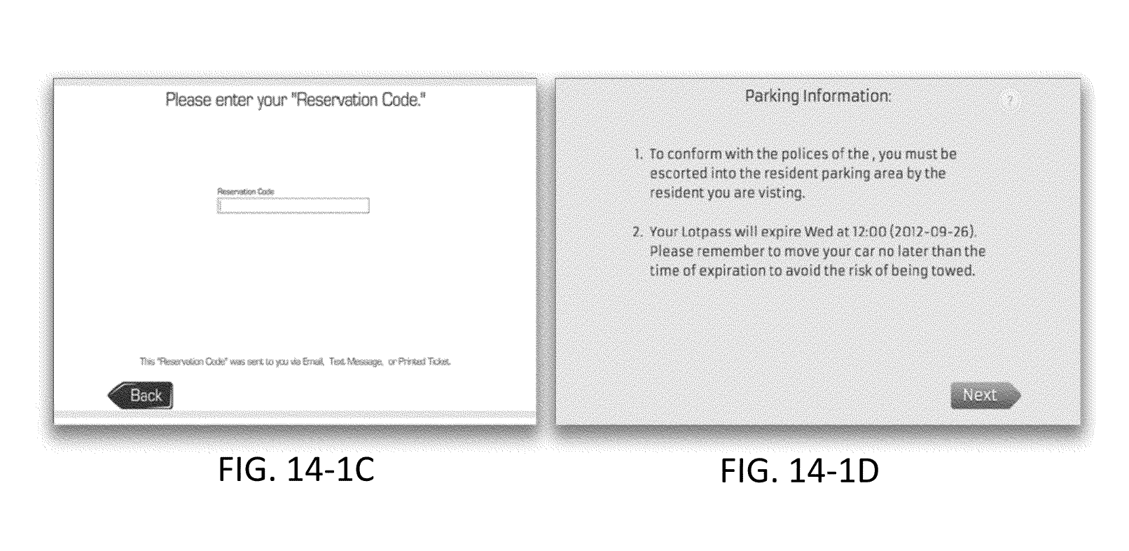

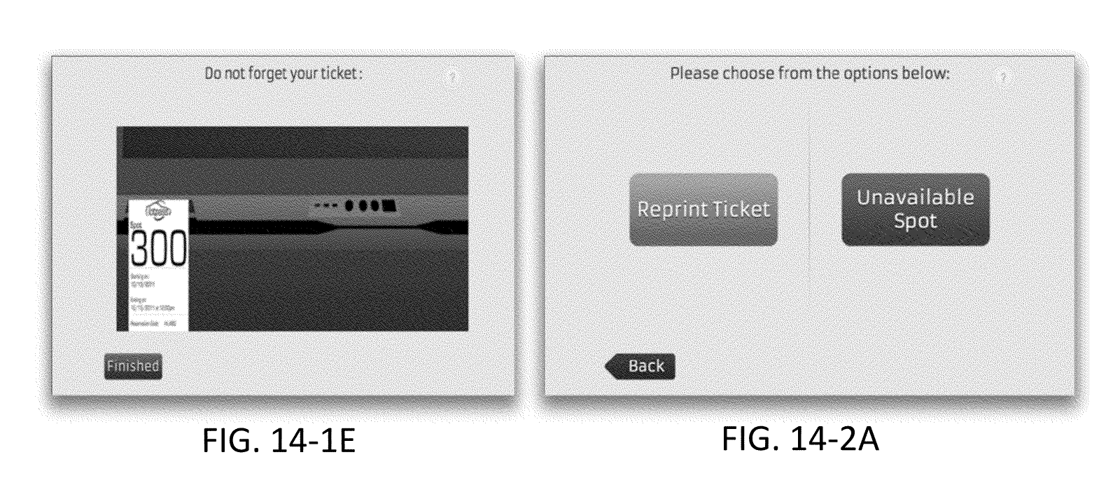

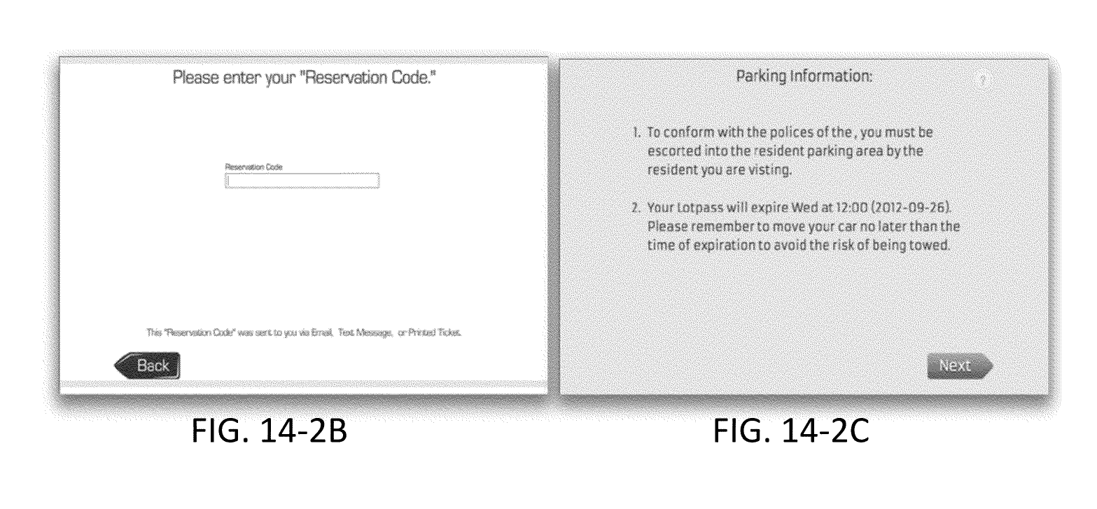

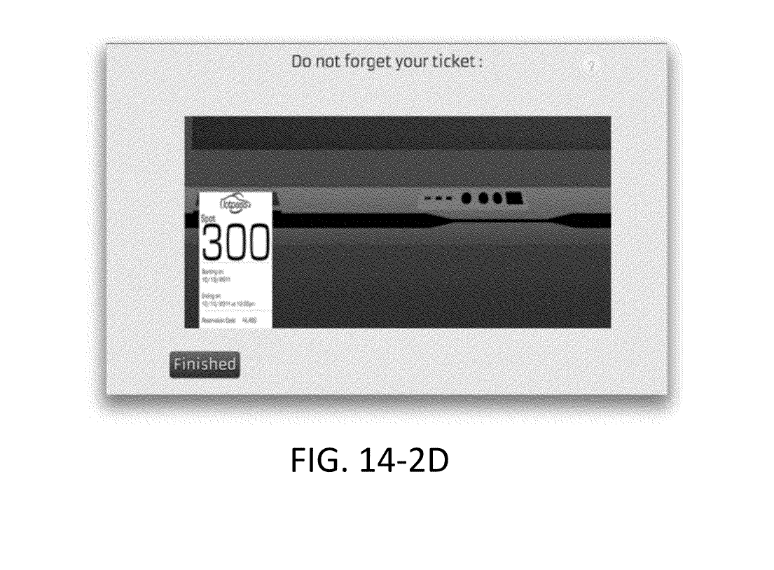

Various exemplary methods are described below. However, it is to be understood that the specific order in which the examples below are described may vary in accordance with this subject disclosure. Likewise, various steps in the process may be performed in a different sequence and/or removed from the various routines described below. FIGS. 2-6 illustrate exemplary work flow embodiments for the parking space reservation system 10. FIGS. 7, 8, 9, 12, and 13 depict various exemplary block diagrams for the various exemplary work flow embodiments. And, FIGS. 7A-7N, 8A-8I, 9A-9C, 10A-10F, 11A-11D, 12A-12K, 13A-13E, and 14(1A)-14(2D) provide various exemplary graphical user interfaces that correspond to the various exemplary block diagrams for the parking space reservation system 10.

A. Resident Rents a Parking Space

According to the parking space reservation system, when a resident wishes to rent a parking space, the following routine may be followed. Referring to FIGS. 2, 7 and 7A-7N, the method for a resident renting a parking space begins, for example, at step S100 (as shown in FIG. 7) in which the resident identifies herself as a resident.

Initially, the parking space reservation system may render a first welcome screen, as shown in FIG. 7A. In step S110, the parking space reservation systems queries the resident to either sign in, sign up for participation in the application, or proceed forward using a reservation code. In the event that the resident selects the action to Sign In at the parking space reservation system, the process proceeds to step S115. Otherwise, the process proceeds to steps S190 and S195, where the resident can create a profile. Upon creation of the profile, at step S195, the parking space reservation system, retrieves the profile and then proceeds to step S115.

In step S115, from a dashboard interface, the resident is able to select among being able to rent parking, sell or list their parking, access their profile or access their history in the parking space reservation system. When the resident selects Rent Parking, the process proceeds to step S120.

In step S120, the routine requests the resident to select a date on which they would like to rent parking. In this example (FIG. 7E), the resident selects a period of one day starting on September 26 and ending on September 27. The dates may be manually input or selected from a drop down menu or selected on a calendar. A full day may be defined at any interval. According to one example, the access to the parking space within the parking structure is designed to terminate at noon on the ending date.

Although this example shows the rental of one day, it is to be understood that the rental time frame may vary from days, hours, minutes and/or any increment of time. That is, the parking space may be available for rent for any period of time. An example of this may be where the resident who has decided to rent their space has a job in which she works between the hours of 8 am to 5 pm and her parking space is vacant for that entire period of time. That resident may choose to make their parking space available for rent during that time to one, or many, guests seeking rental of her space between 8 am to 5 pm. Once the resident reserving the parking space has selected a preferred date and selects next, the routine proceeds to step S125.

In step S125, the resident is asked to enter the number of parking spaces they would like placed in their cart for rent before the routine proceeds to step S130.

In step S130, the resident may review their reservation which may include information about the parking spaces they intend to rent, the start and end date for each of the associated parking spaces as well as the cost for each of the various rental spaces. Also, the specific parking space location may be identified.

To ensure some form of equality amongst resident participants to the parking space reservation system 10, the parking space reservation system may establish a priority based algorithm, such as first in first out meaning that the order in which the various parking spaces are rented are based on when the resident owner listed their parking space for rent. Various other schemes may be provisioned and/or contemplated by the parking space reservation system 10. In another example, the parking space reservation system may intelligently determine which parking spaces are closest to each other and assign them accordingly, such as here in which three parking spaces have been reserved that are conveniently located adjacent to each other. If the resident would like to edit the reservation, the resident may select the edit function and the routine will proceed to step S175.

In step S175, the resident may make changes to any one of the specific reservations, such as where the resident may select the Add More radio button to add more parking spaces for rent to their reservation, as shown in step S180. From there, the process proceeds back to step S125 where the routine allows the user to select more spaces and review their reservations again. If no new spaces are selected, such as shown in this example, the routine would proceed back to step S130 where the resident can review their reservation for the rental of the parking spaces. Once the resident is satisfied with the details of their reservation, they may select the Next button which would then proceed to step S140.

In step S140, the resident can agree to the terms of the rental agreement. These terms may outline the various processes for contacting an owner of the space, payment disputes, and the like. Upon agreement with the terms, the process proceeds to step S150, where the resident's billing information and credit card information may be manually input or it may be swiped in a card reader.

In step S160, the resident may associate the guest information with the reservation and each of the assigned rented parking spaces. In this example, the resident has an option to assign the parking spaces to specific guests and then to send them the reservation code for their particular reserved parking location (See FIG. 7K). When the guest arrives, the guest can access the reservation at the kiosk and print out their parking permit. Once the guest begins to access the parking space reservation system 10, a notification can be transmitted to the guest-receiving resident so that she can proceed down to the lobby and meet the arriving guest to escort them into the secured parking area.

In an alternative, a message can be sent to the guest before he arrives so the guest can conveniently print the parking permit prior to arriving at the parking lot. The reservation may be transmitted to the guest in a variety of different modes including but not limited to, email, short message service (SMS), text, voice and/or any other suitable transmission medium. (See FIG. 7L)

In various parking structures where the rented reserved parking space is located behind a security gate, access into the area behind the security gate would be necessary. Various access control measures can be implemented. One example of granting access to a secure area may involve a bar code, a temporary access code, or other security measure that would enable the guest access into the secure area to park in the secure parking space.

Once the resident has elected to associate the guest with the reserved parking space, and has determined whether to send the reservation code to the guest, the resident may move forward in the routine by selecting Next. The resident may be prompted to read and agree to the terms set out by the parking space reservation system (as shown in step S165) before proceeding to the next step S170.

In step S170, a parking permit may be generated. The parking permit may be provided in a variety of different modes, such as by printing, emailing for use as an electronic parking permit and/or any other method for dispensing and transmitting notification of a parking permit.

The process then ends.

If the resident has associated the reservation with a particular guest and the guest is notified via email and/or other method, the guest can conveniently log in, pay for and print out the parking permit pass remote from their personal computer via their own printer before they arrive at the property.

After the purchase has been made to rent a particular parking space the guest or resident owner of the parking space may be notified by text, SMS, email, and/or other mode of communication that his available parking space has been reserved for a particular date and time so that she can properly allocate for the use of her parking space in the parking space reservation system program.

After payment has been made and authorized, monetary compensation can be credited to that resident owner's financial institution, and the kiosk owner's financial institution. Alternatively, the value to the resident owner may come in a variety of different forms, such as mentioned above a credit for future use in the parking space reservation system 10. If the dwelling association chooses to pay a monthly fee, then the residents will not be involved in financial transactions.

B. Resident Signs Up to Participate in the Parking Space Reservation System

According to the parking space reservation system, when a resident wishes to enroll in and participate in the parking space reservation system, the following routine may be followed.

Referring to FIGS. 2-6, 8 and 8A-8H, a resident can enroll in and participate in the parking space reservation system program by either listing his space for rent or to rent the spaces of other residents within their dwelling complex. The system and method for enrolling a resident renting a parking space begins after the resident identifies herself as a resident or guest. In this example, the resident enrollment will be described. The process for enrolling a guest is similar. Once the resident has selected resident, the routine proceeds to step S110.

In step S110, the parking space reservation systems queries the resident to either sign in, sign up for participation in the application, or proceed forward using a reservation code. The reservation code has the flexibility to be tailored to the dwelling complex based on how involved the dwelling complex would like the guests to be. In this example, the resident selects Sign Up for the parking space reservation system and the process proceeds to step S190.

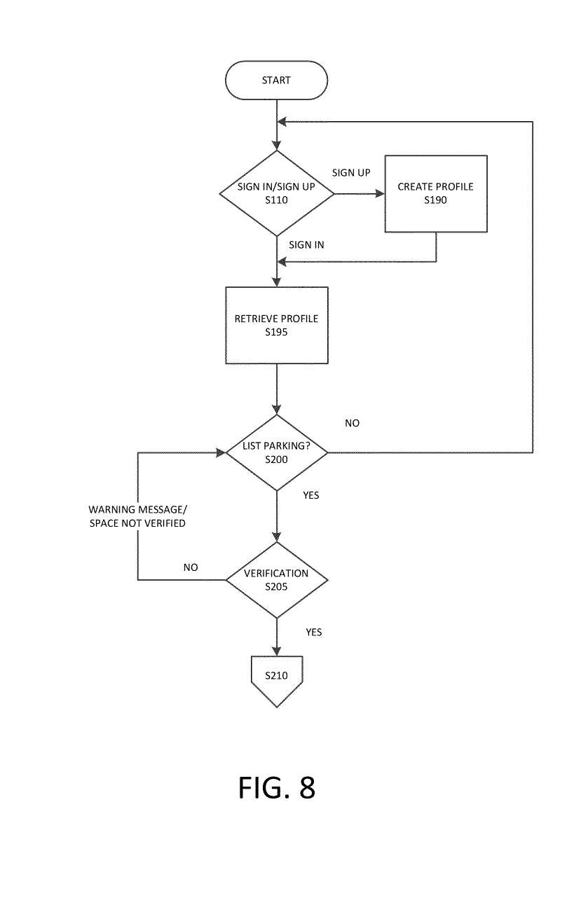

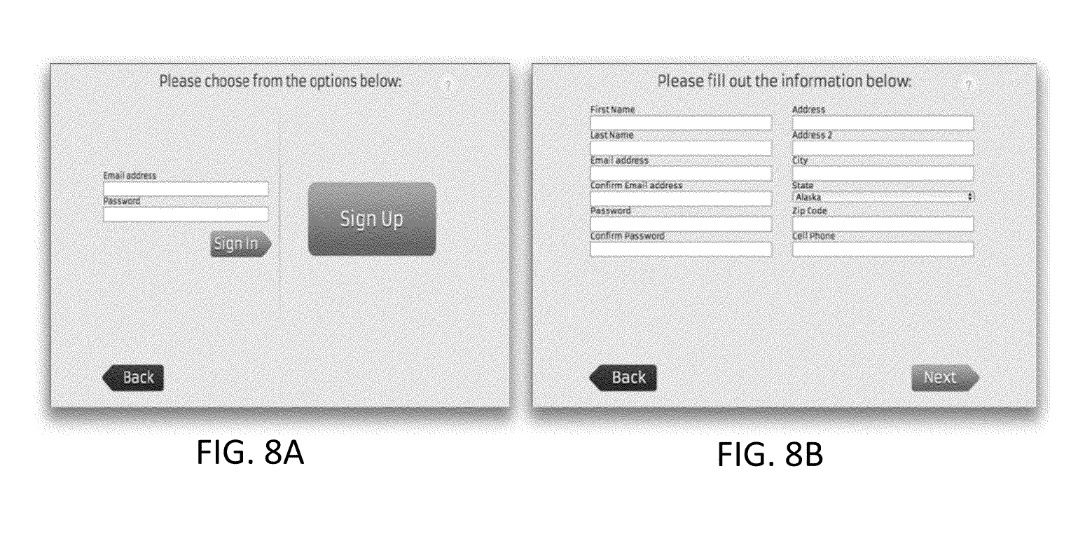

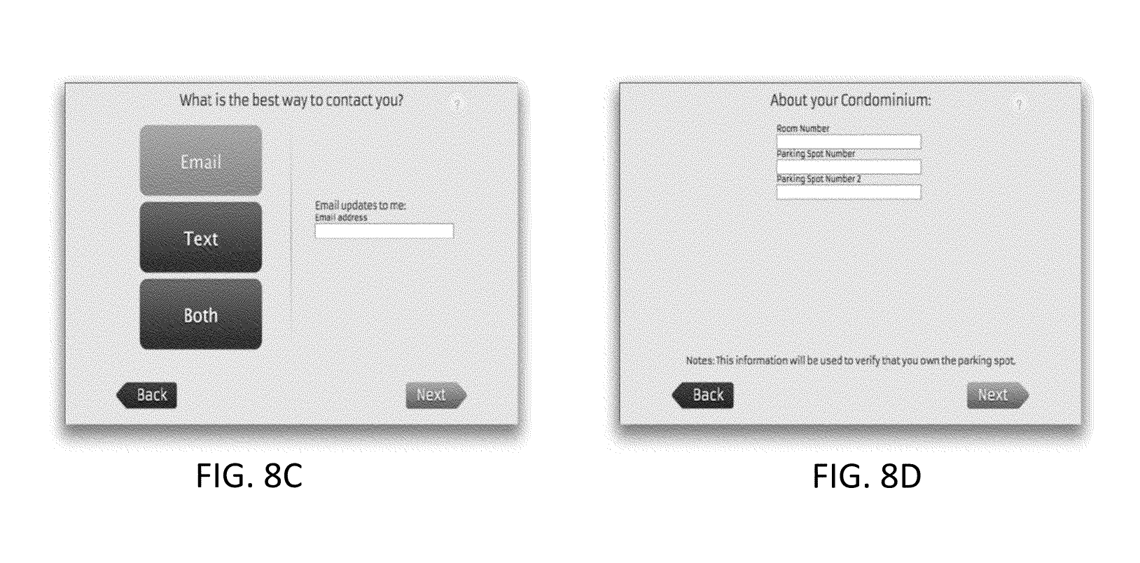

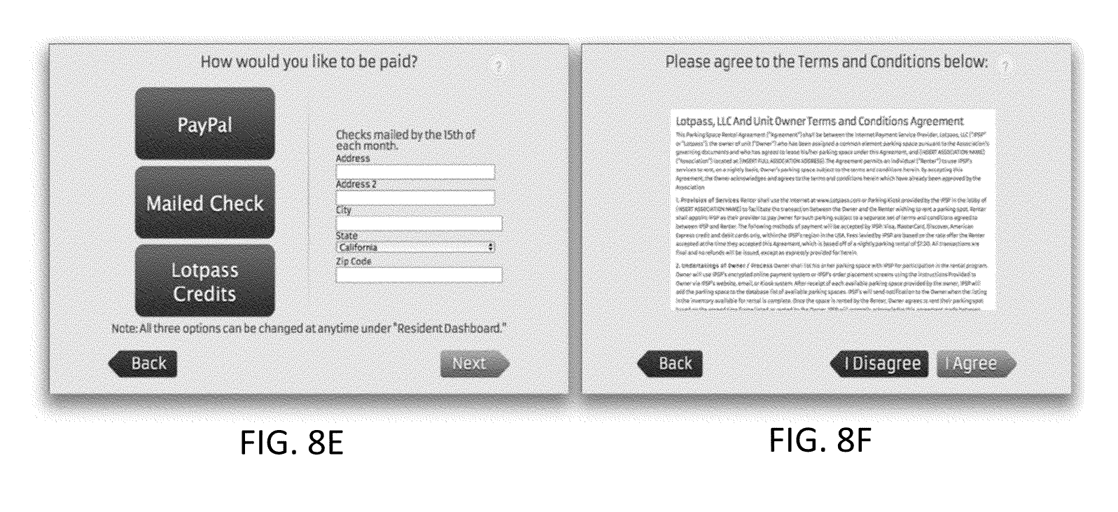

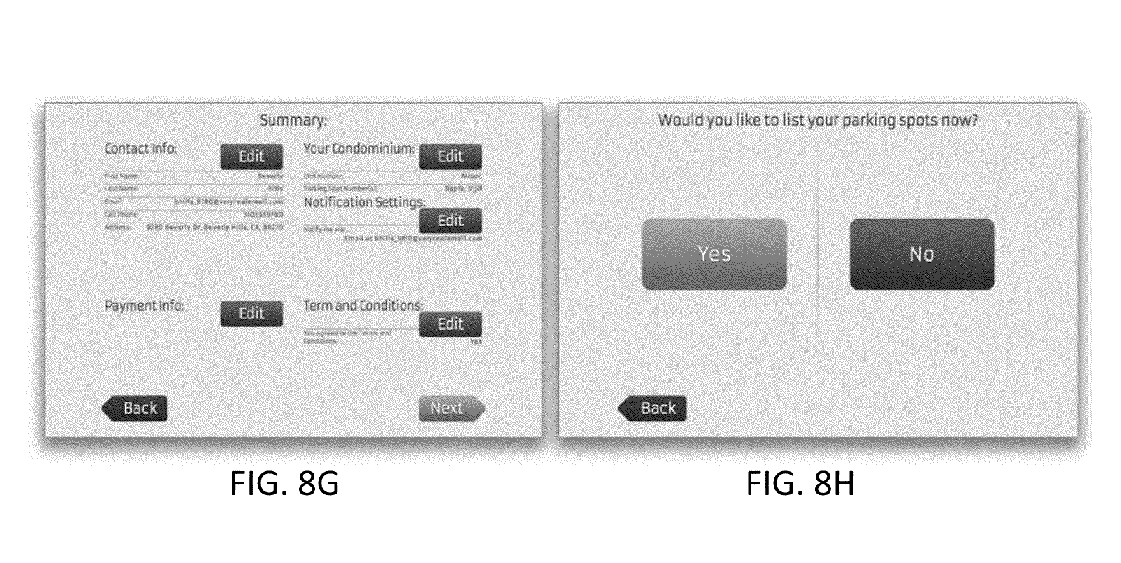

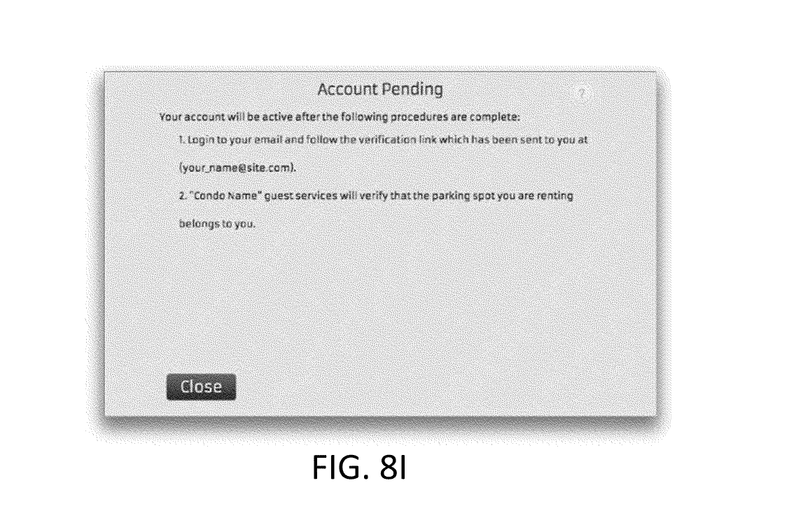

In step S190, the resident is able to insert their pertinent identification information, such as name, address, phone number, short messaging service preference, condominium information, or the like, email, password. Once the resident has completed entry of the identification information, she can advance forward by selecting Next through each one of the steps listed and as shown in FIGS. 8B-8G and proceeding to step S195, where the parking space reservation system will retrieve the profile information the user input and proceed to step S200. A variety of alternative are available in accordance with the subject disclosure. As shown, the payment settings may be electronically tied to a billing system, such as PayPal that is tied to the residents email address and banking institution, a bank and/or any other financial institution. In the alternative, the preferred payment setting may be designated as generating a check at a given periodic time and/or credits as discussed above.

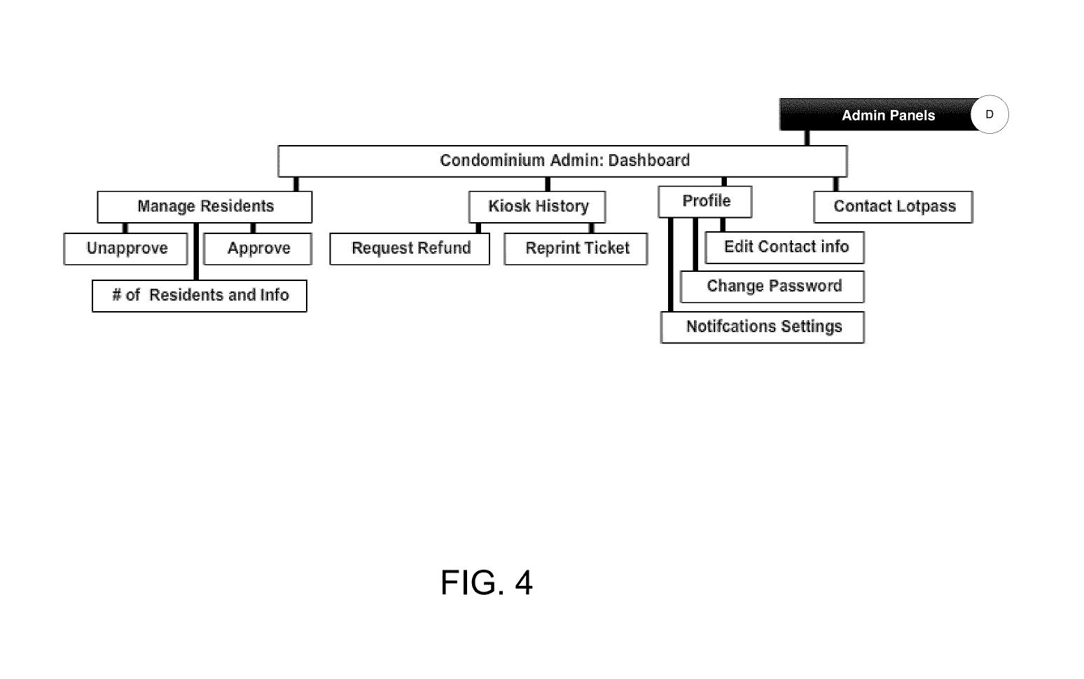

In step S200, the resident may identify their assigned parking space number and the other information, such as their condominium number. Once the information is complete, the routing may verify the parking space information with the known resident address information at step S205. As shown in FIG. 81, the resident will be given notification that their account is pending verification, until they have been approved. That verification may be tied as a look up table and/or tied into the dwelling complex computer system. Likewise, one resident owner of a parking space may allow another resident owner to use his parking space and that authorization can be verified at this point. FIGS. 4-6 illustrate the Administrative panels, where the verification may take place based on approval by the condominium office. That is, the resident information is managed at the condominium Admin: Dashboard level. However, it is further shown that various levels exist at the Admin Panel level, such as Regional Administration where various condominiums can be managed and the information associated with them as well. (See FIGS. 4-6) In addition to the Condominium and Regional Administration, a Super Administration level exists on the dashboard where the administrator would be privy to higher level approval information, such as managing refunds, sending notifications, profiles, as well as various other facets described in the figures. Referring back to step S205, once the information has been verified, the routine proceeds to step S210.

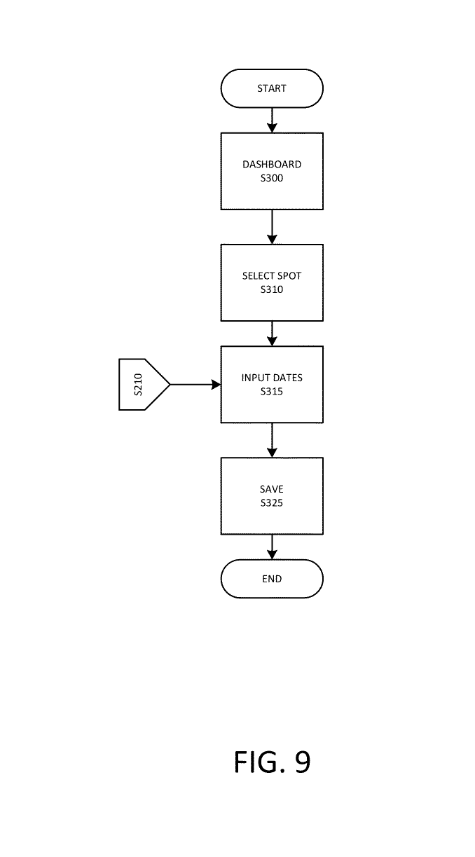

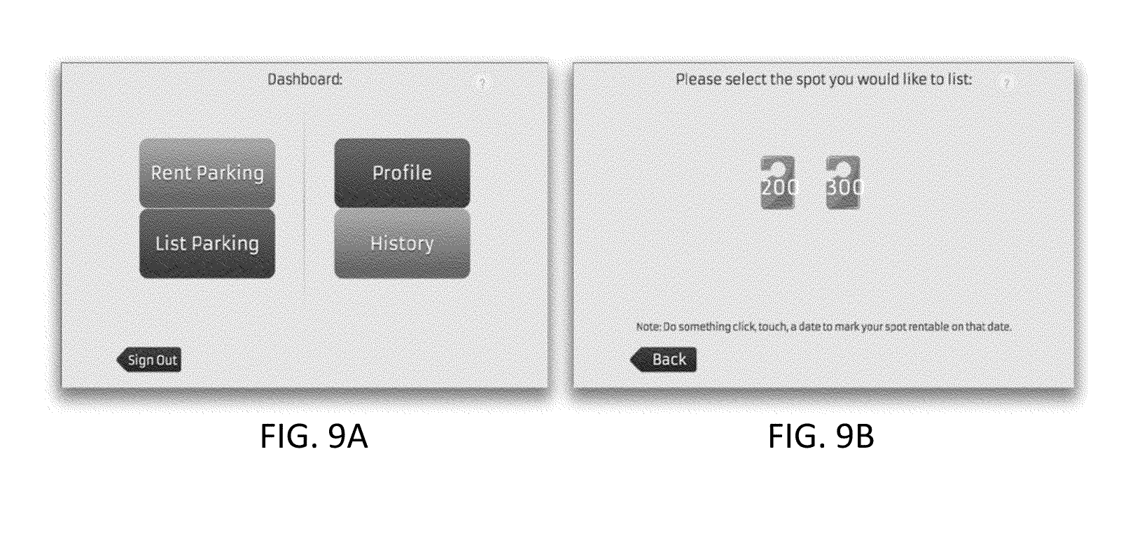

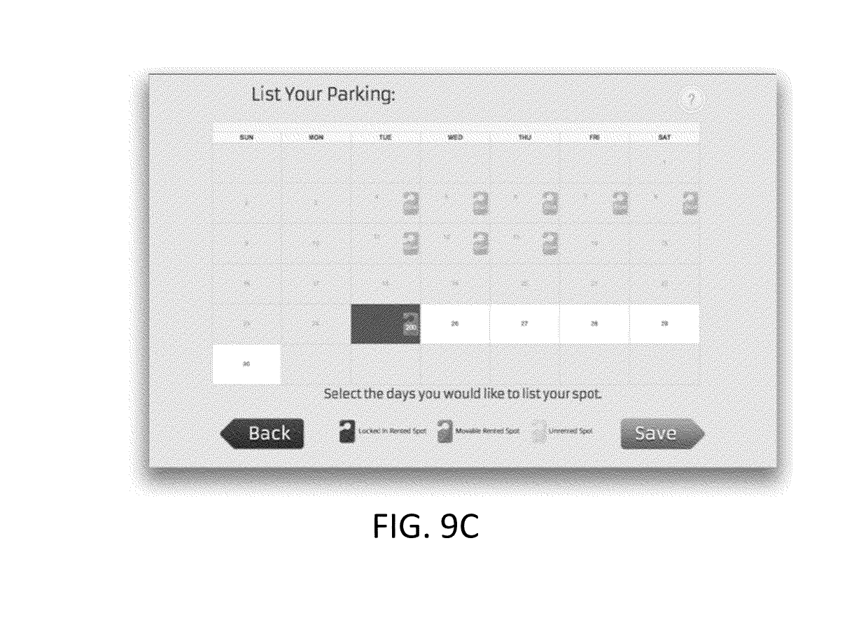

In step S210, the routine jumps to step S315 of FIG. 9, where the resident can select which dates he wants his space to be available for rent. The selected space and dates are saved at step S325.

C. Resident Lists Parking Space for Rent

Referring to FIGS. 2-6, 9, and 9A-9G, once the resident has enrolled in the parking space reservation system program, the resident can list their parking space for rent. The system and method for listing a parking space begins at step S300 after the resident has identified herself as a resident and signed in. The routine then proceeds to step S310.

In step S310, the resident can select the space which they want to place up for rental. As shown in FIG. 9B, the resident has multiple spaces assigned to them. Upon selection of the space, the process proceeds to step S315, where dates are selected that the selected spot will be available for rental.

In step S315, the resident can view and select which dates they wish to make their parking spaces available for rent based on their availability. As shown, the interface may render a calendar and virtual icons representing the resident owner's parking spaces and their dates of availability may also be displayed. The color coding scheme as mentioned above in more detail may be implemented to indicate the ability to revise the scheduled parking space reservation. The resident may select one of their available assigned parking spaces over a particular date and make that parking space available for rent on that day. Likewise, the resident owner can remove an available rental day by deselecting the assigned parking space off of a particular pre-assigned calendar day to make the space unavailable for rent.

In step S315, the resident may set up the dates available for rent. For example, the resident owner has decided to allow her parking space 200 to be available for rent starting on Aug. 26, 2012 and ending five days later on Aug. 30, 2012. An automatic repeat option may be available where the resident owner would like to repeat the same type of rental, such as for example where the resident owner would like to make their parking space 200 available for rent every week on the 26^{th} through the 30^{th} of each month. As mentioned previously, it is to be understood that the rental time frame may vary from days, hours, minutes and/or any increment of time. That is, the parking space may be available for rent for any period of time. An example of this may be where the resident who has decided to rent their space has a job in which she works from the hours of 8 am to 5 pm and her parking space is vacant for that period of time. That resident may choose to make their parking space available for rent during that time to one, or many, guests seeking rental of her space for the time frame between 8 am to 5 pm. Once the resident reserving the parking space has selected a preferred date and saved their entry and selects Next, the routine proceeds to step S325.

In step S325, the resident may be prompted to review and accept by agreeing to the terms of the Parking space reservation system program and saving the reservations into the system.

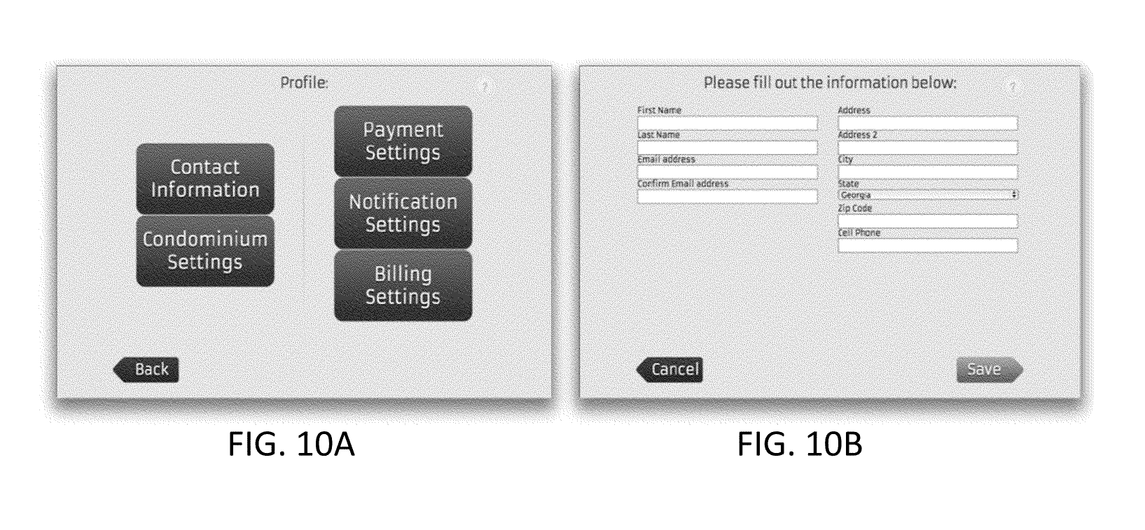

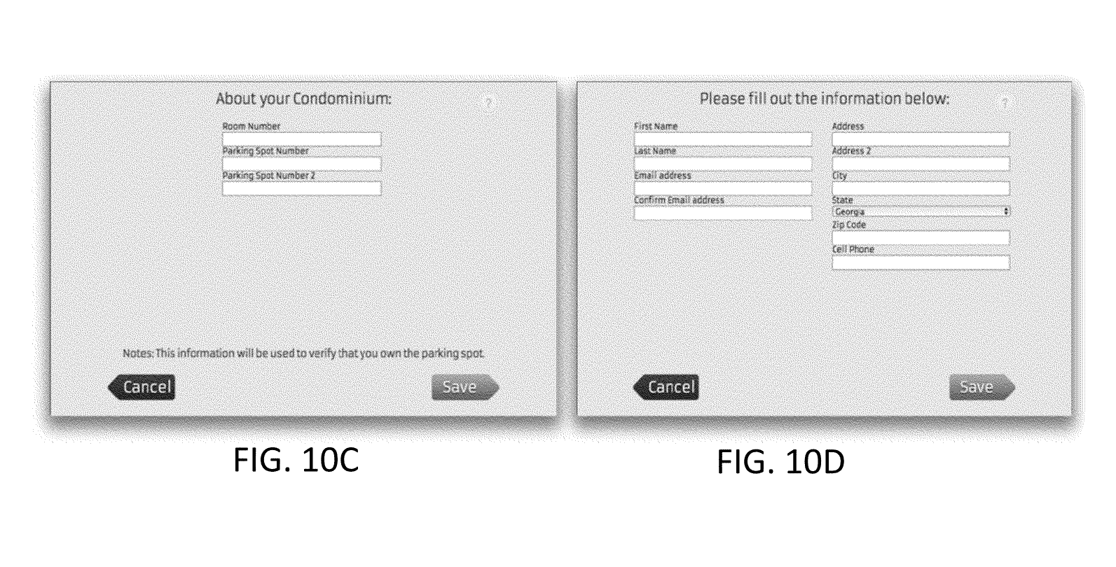

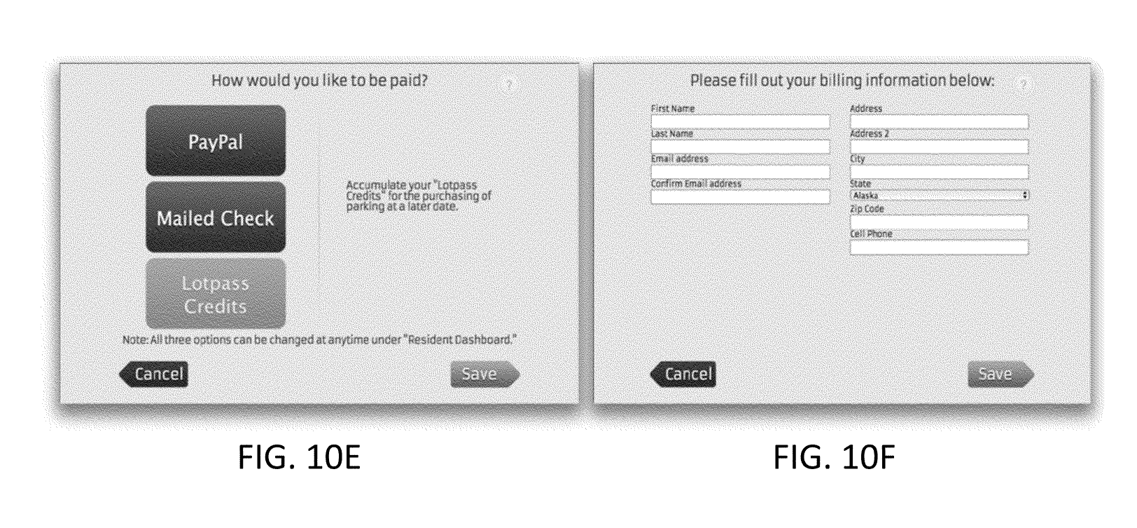

FIGS. 10A-10F depict the method that a resident would follow so that they can maintain and update their profile information. This method can be used to update payment and contact preferences, as well as the allow the user to add and remove parking spaces that he wants available for rent. For example, if the resident has two deeded parking spaces, they may want to reserve one of them for their sole use.

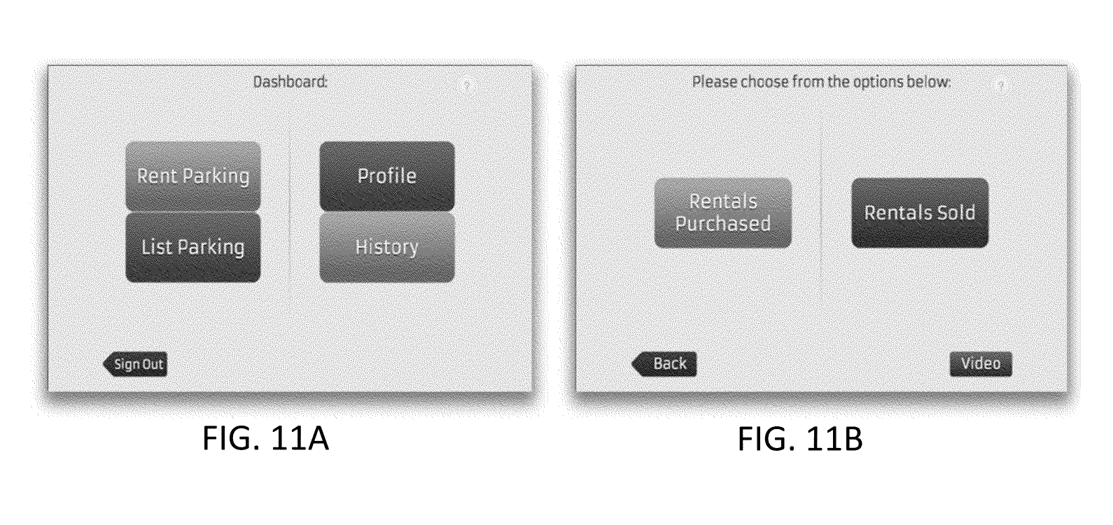

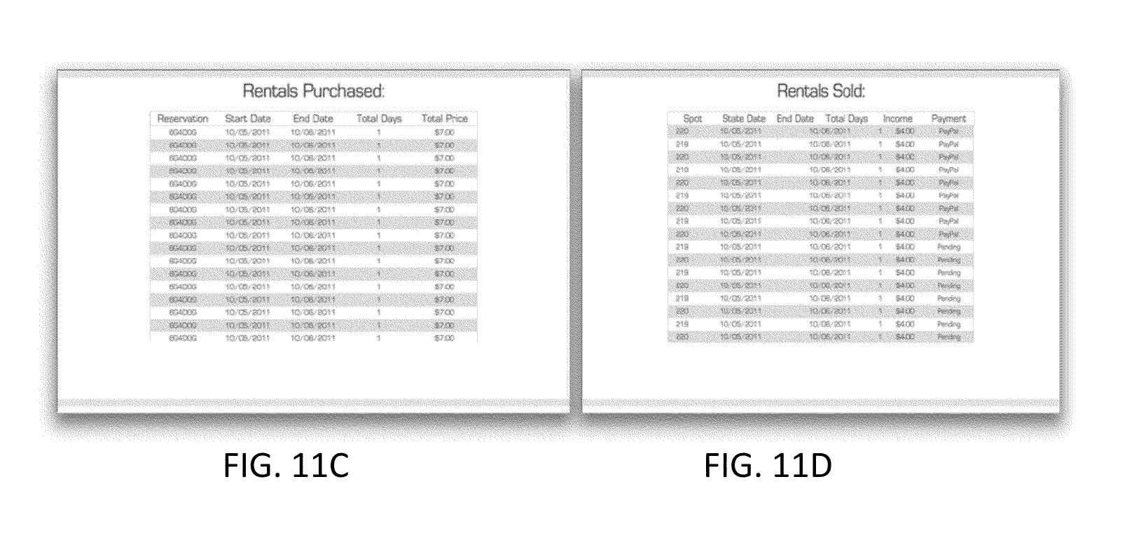

FIGS. 11A-11D depict the method where a resident can enter the systems and view their rental history over any length of time.

E. Guest without Reservations

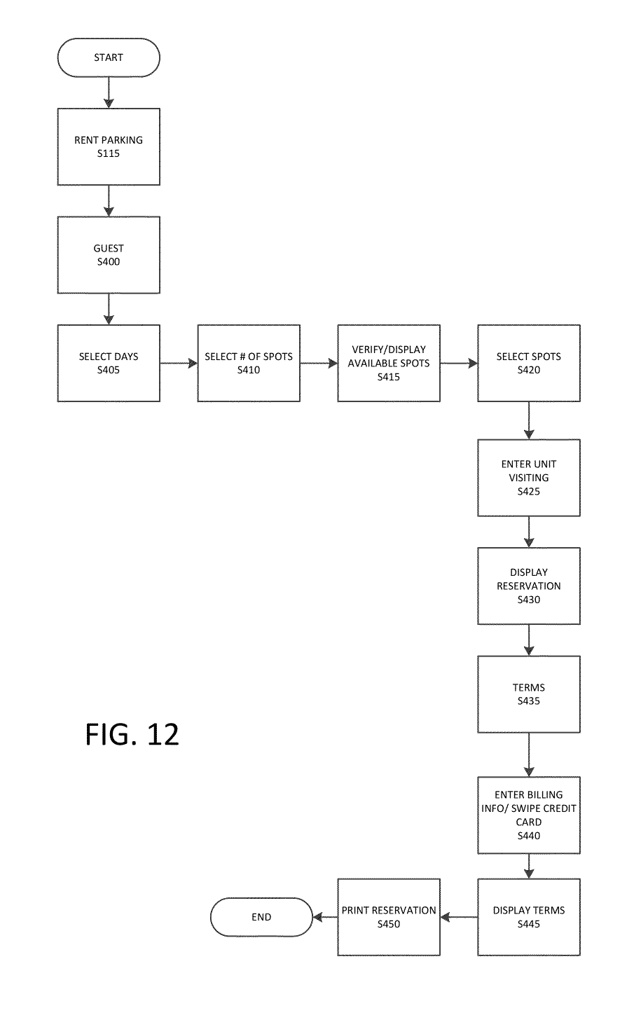

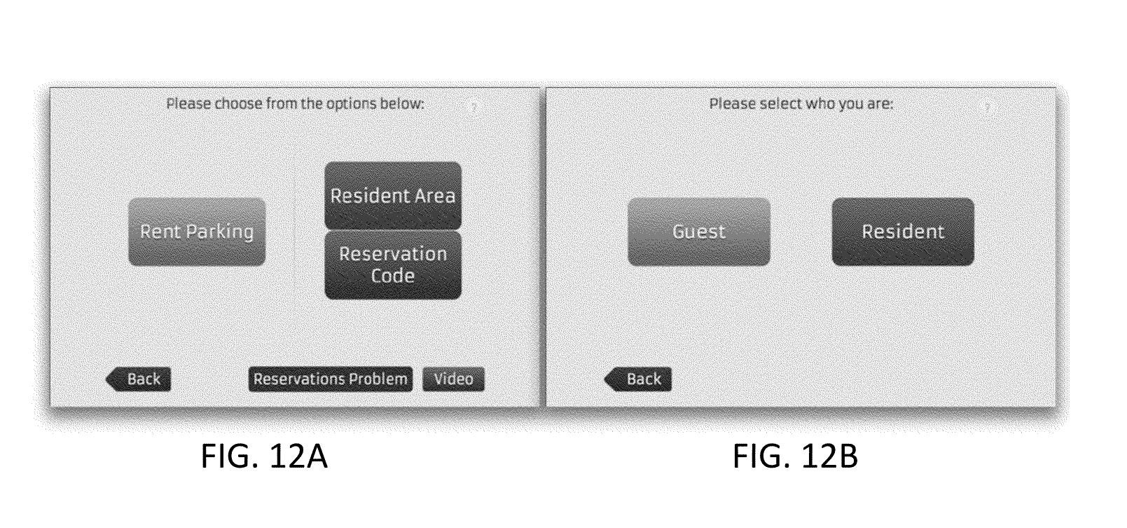

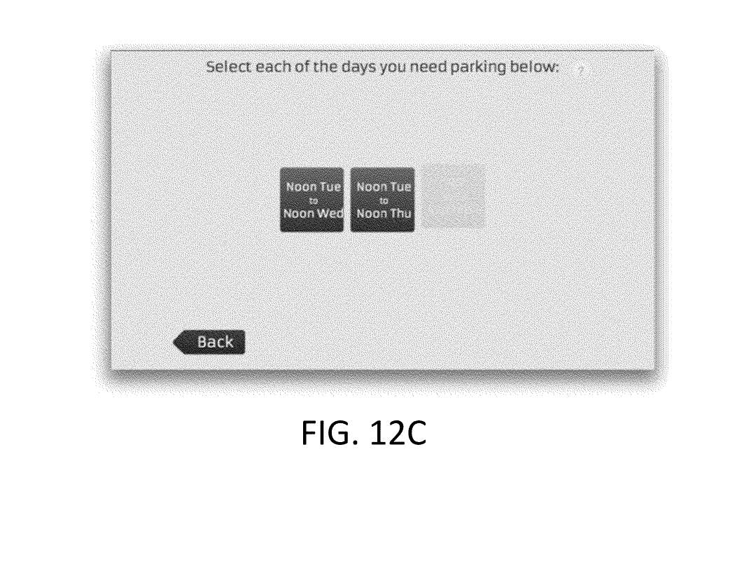

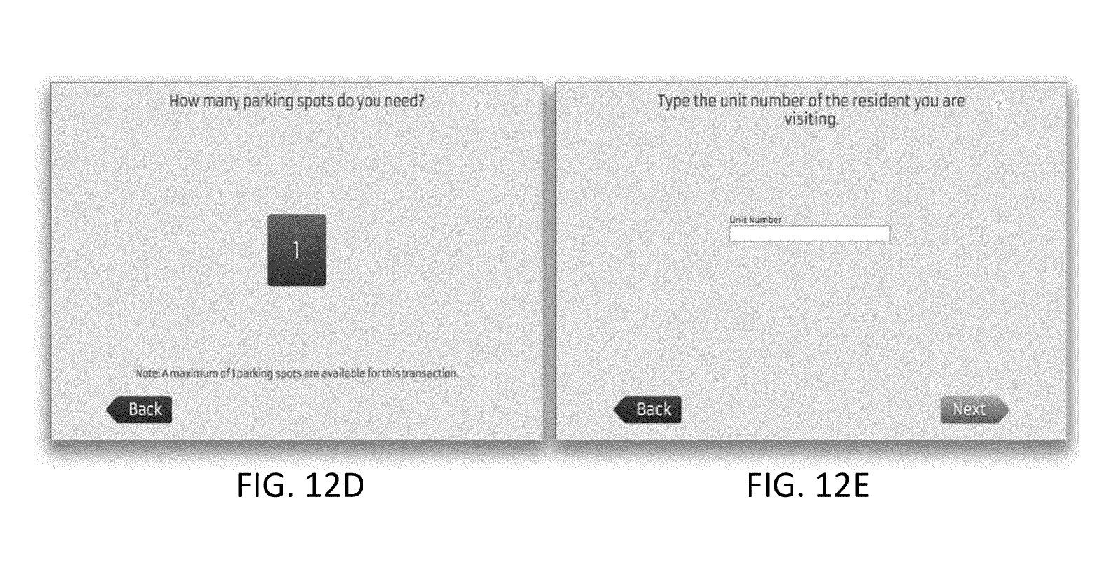

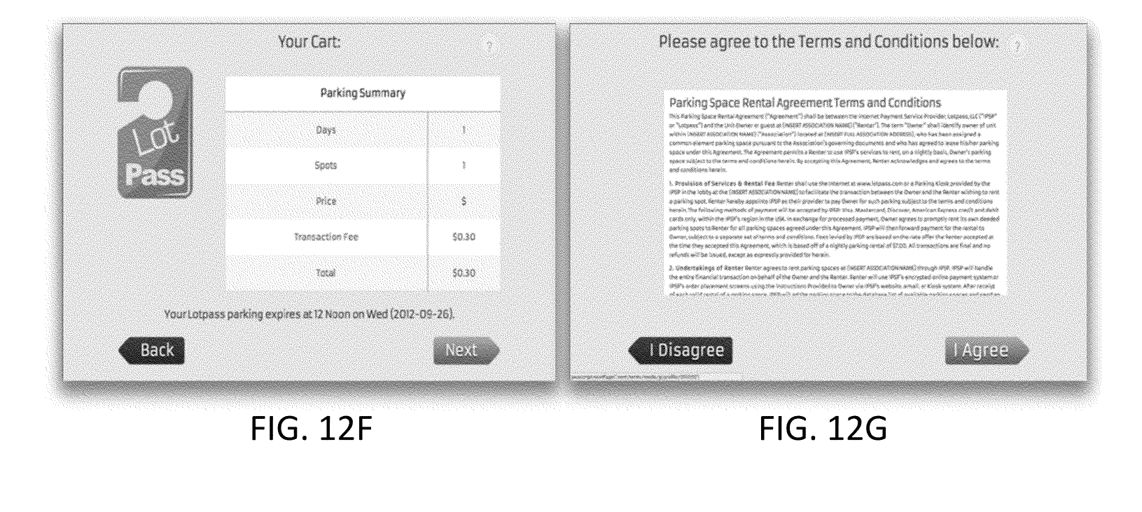

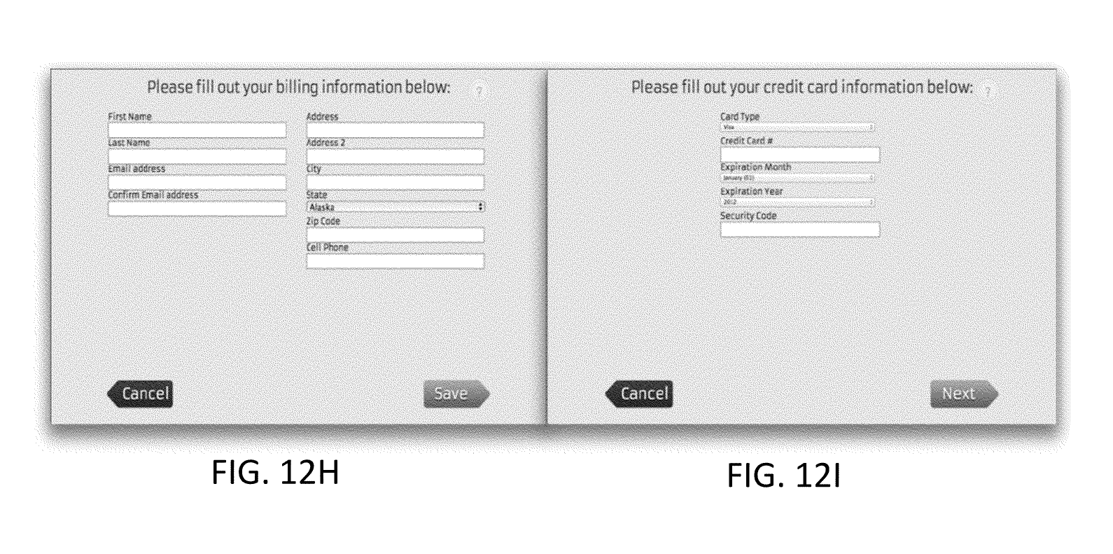

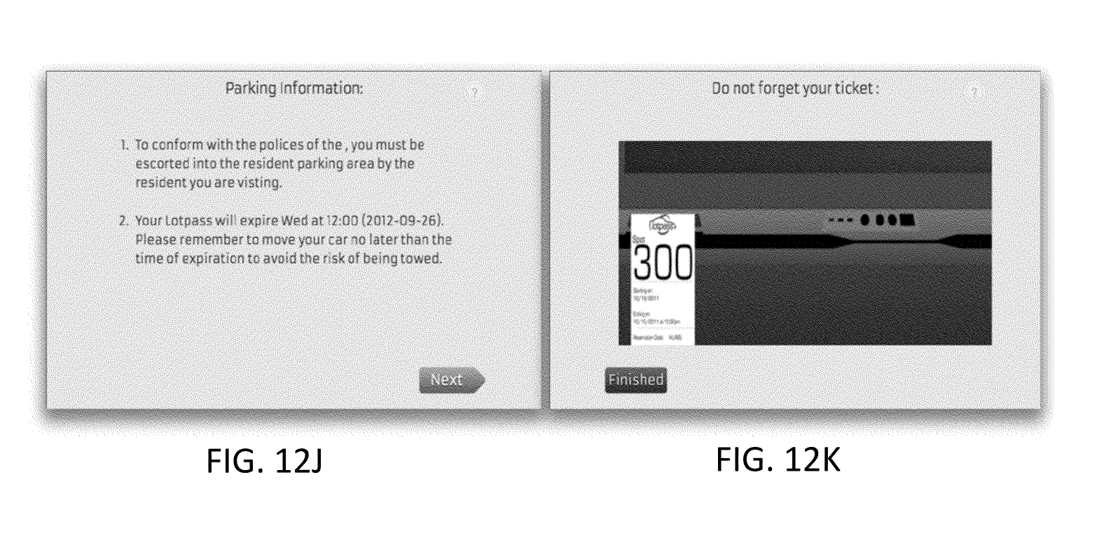

Referring to FIGS. 2, 12, and 12A-12K, the system and method for a guest without a reservation who desires to rent a parking space begins at step S115, where the Guest selects the radio button to indicate that they would like to rent parking. The process then proceeds to step S400 in which the guest identifies herself as a guest. Here, the Guest will select Rent Parking, since, in this example, the Guest does not have a Reservation Code. The process then proceeds to step S405, where the Guest will select the number of days he would like to rent parking.

In step S410, the system will ask the guest to select the number of parking spots they wish to purchase. Once the guest has selected their desired number of parking slots, the routine will proceed to step S415. At step S415, the system will search among the parking spaces within the dwelling complex and display the spaces that fit the criteria selected by the guest.

In step S420, the guest may review the various parking spaces that may be reserved along with the cost for each parking space reservation. The process then proceeds to step S425, where the guest is asked to input the condominium number they are visiting. This input may trigger a verification that the guest is authorized to be on the premises at that time.

The process then proceeds to step S430, where the reservation is displayed, by selecting next, the process proceeds to step S435, where the guest agrees to the terms of the rental agreement. Once the guest selects Done, the routine proceeds to step S440 in which the guest can again verify the reservation and the cost associated with the rental of each of the various parking slots being reserved and accept the reservation by selecting next. Step S440 may be used to verify, but may not be implemented in all scenarios. The routine then proceeds to step S445.

In step S445, the guest may be requested to insert information. That is, the guest may be prompted to include their name, address, email, phone number, the dwelling room number of the resident being visited, car make, model and color, and whether they can accept short message service (SMS) for notifications. Once, the requisite information is input and the guest selects SAVE, the routine will proceed to allow the guest to input payment information. The guest is prompted to make payment for the reservation. The guest may use for example a credit card to finalize payment of the reservation. Once payment is processed, the routine proceeds to step S450.

In step S450, a parking permit is generated and printed.

D. Guest with Reservations

Referring to FIGS. 2, 13, and 13A-14-2D, in accordance with the Parking space reservation system. The Process begins at the step S500, where the guest is directed to a home screen.

In step S500, where the guest does have a reservation code, the guest will select Reservation Code and the routine will proceed to step S505.

In step S505, the Parking space reservation system requests the reservation code number. Once the guest inserts the reservation code and selects Next, the reservation code may be verified. Upon verification, the routine advances to step S515.

However, if the reservation code is not verified because it was invalid or input incorrectly, the process jumps back to step S500, where the guest can either reenter the reservation code at step S505 or proceed to step S525 where reservation problems are handled by the system.

Now moving back to step S515, the guest may be prompted to read and agree to the terms set out by the parking space reservation system program before proceeding to the next step S520.

In step S520, a parking permit is generated and printed.

Referring now to FIGS. 14-1A-14-1E and step S525, the parking space reservation system can help guest resolve issues related to reservation code problems. For example, as illustrated in 14-1A-14-1E, where a reservation ticket has been misplaced, the system will allow the guest to reprint the missing ticket.

Additionally, referring now to FIGS. 14-2A-14-2D, where a user finds that the spot that was originally reserved, now is occupied by someone or blocked for some other reason, the parking reservation system, may find another available parking space and reassign the guest with new, previously unreserved space.

The illustrations and examples provided herein are for explanatory purposes and are not intended to limit the scope of the appended claims. It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution (and/or control programs) and a component may be localized on one computer and/or distributed between two or more computers. As another example, an interface can include I/O components as well as associated processor, application, and/or API components, and can be as simple as a command line or a more complex Integrated Development Environment (IDE).

Furthermore, the subject disclosure may be implemented as a system or method using standard programming and/or engineering techniques to produce software, firmware, hardware, or any combination thereof to control a computer to implement the disclosed subject matter. The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims.

1. A method for reserving parking spaces in a private multi-dwelling complex comprising:
a parking space located within the private multi-dwelling complex owned by a first resident, wherein the first resident registers the parking space for temporary use by other residents living in the private multi-dwelling complex, using a parking reservation system; and
a second resident reserving the parking space for use during a predetermined temporary length of time, wherein the second resident accesses the parking reservation system to select and reserve the parking space for use during the predetermined length of time.

2. The method of claim 1, wherein the parking reservation system contains a database of all parking spaces located in the private multi-dwelling complex, wherein based on the reservation by the second resident, the parking space reservation system identifies the parking space belonging to the first resident and places a reservation indication in the database related to the predetermined temporary length of time.

3. The method of claim 1, further comprising a verification method to verify that first resident is authorized to register the parking space for temporary use by other residents.

4. The method of claim 3, wherein the verification method comprises:
accessing a computer system of the private multi-dwelling complex to cross check the first resident's ownership of the parking space with the registration of the parking space.

5. The method of claim 3, wherein the verification method comprises:
sending a notification to an administrator of the parking space reservation system; and
the administrator crosschecking ownership information of the parking space with the first resident's ownership information, and upon verification that the first resident is the correct owner of the parking space, releasing the parking space for temporary use by other residents.

6. The method of claim 5, wherein the verification method further comprises:
authorizing the first resident to register the parking space and placing the parking space in the parking space reservation system as a parking space available for rent by other residents living the in the multi-dwelling complex.

7. A system for reserving parking spaces in a private multi-dwelling complex comprising:
a kiosk containing a parking reservation system identifying a parking space located within the private multi-dwelling complex owned by a first resident, wherein the first resident registers the parking space for temporary use by other residents living in the private multi-dwelling complex; and
a second resident reserving the parking space for use during a predetermined temporary length of time, wherein the second resident accesses the parking reservation system to select and reserve the parking space for use during the predetermined length of time.

8. The system of claim 7, wherein the kiosk contains a database of all parking spaces located in the private multi-dwelling complex, wherein based on the reservation by the second resident, the parking space reservation system identifies the parking space belonging to the first resident and places a reservation indication in the database related to the predetermined temporary length of time.

9. The system of claim 7, further comprising a verification system that verifies that first resident is authorized to register the parking space for temporary use by other residents.

10. The system of claim 9, wherein the verification system accesses a computer system of the private multi-dwelling complex to cross check the first resident's ownership of the parking space with the registration of the parking space.

11. The system of claim 9, wherein the verification system:
sends a notification to an administrator of the parking space reservation system; and
the administrator crosschecking ownership information of the parking space with the first resident's ownership information, and upon verification that the first resident is the correct owner of the parking space, releases the parking space for temporary use by other residents.

12. The system of claim 11, wherein the verification system:
authorizes the first resident to register the parking space and places the parking space in the parking space reservation system as a parking space available for rent by other residents living the in the multi-dwelling complex.
